(19) United States
(12) Patent Application Publication
(10) Pub. No.: US 2026/0291673 A1
(43) Pub. Date: Sep. 24, 2026

(54) MULTI-UPLINK TRANSMISSION VALIDATION DURING FULL-DUPLEX OPERATIONS

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Mohammed JABI, San Diego, CA (US)

(21) Appl. No.: 19/535,740

(22) Filed: Feb. 10, 2026

Related U.S. Application Data
(60) Provisional application No. 63/775,052, filed on Mar. 20, 2025.

(51) Int. Cl. H04L 5/00; H04L 1/1867; H04L 5/14

(52) U.S. Cl. CPC H04L 5/0044; H04L 1/1896; H04L 5/1453

(57) ABSTRACT

Various aspects of the present disclosure generally relate to wireless communication. In some aspects, a user equipment (UE) may receive, from a network node, configuration information that indicates a configuration type for wireless communications during one or more subband full-duplex (SBFD) time intervals and one or more non-SBFD time intervals. The UE may receive, from the network node, control information that schedules a set of uplink messages. The UE may transmit, to the network node, a first uplink message from the set of uplink messages in accordance with the first uplink message being valid, where the first uplink message may be valid in accordance with being scheduled during a valid symbol-type and based on the configuration type. Numerous other aspects are described.

### CROSS-REFERENCE TO RELATED APPLICATION

This Patent Application claims priority to U.S. Provisional Patent Application No. 63/775,052, filed on Mar. 20, 2025, entitled “MULTI-UPLINK TRANSMISSION VALIDATION DURING FULL-DUPLEX OPERATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with multi-uplink transmission validation during full-duplex operations.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE) for wireless communication. The UE may include one or more memories and one or more processors coupled to the one or more memories. The one or more processors may be configured to receive, from a network node, configuration information that indicates a configuration type for wireless communications during one or more subband full-duplex (SBFD) time intervals and one or more non-SBFD time intervals. The one or more processors may be configured to receive, from the network node, control information that schedules a set of uplink messages. The one or more processors may be configured to transmit, to the network node, a first uplink message from the set of uplink messages in accordance with the first uplink message being valid, wherein the first uplink message is valid in accordance with being scheduled during a valid symbol-type and based at least in part on the configuration type.

Some aspects described herein relate to a network node for wireless communication. The network node may include one or more memories and one or more processors coupled to the one or more memories. The one or more processors may be configured to transmit, to a UE, configuration information that indicates a configuration type for wireless communications during one or more SBFD time intervals and one or more non-SBFD time intervals. The one or more processors may be configured to transmit, to the UE, control information that schedules a set of uplink messages. The one or more processors may be configured to receive, from the UE, a first uplink message from the set of uplink messages in accordance with the first uplink message being valid, wherein the first uplink message is valid in accordance with being scheduled during a valid symbol-type and based at least in part on the configuration type.

Some aspects described herein relate to a method of wireless communication performed by a UE. The method may include receiving, from a network node, configuration information that indicates a configuration type for wireless communications during one or more SBFD time intervals and one or more non-SBFD time intervals. The method may include receiving, from the network node, control information that schedules a set of uplink messages. The method may include transmitting, to the network node, a first uplink message from the set of uplink messages in accordance with the first uplink message being valid, wherein the first uplink message is valid in accordance with being scheduled during a valid symbol-type and based at least in part on the configuration type.

Some aspects described herein relate to a method of wireless communication performed by a network node. The method may include transmitting, to a UE, configuration information that indicates a configuration type for wireless communications during one or more SBFD time intervals and one or more non-SBFD time intervals. The method may include transmitting, to the UE, control information that schedules a set of uplink messages. The method may include receiving, from the UE, a first uplink message from the set of uplink messages in accordance with the first uplink message being valid, wherein the first uplink message is valid in accordance with being scheduled during a valid symbol-type and based at least in part on the configuration type.

Some aspects described herein relate to a non-transitory computer-readable medium that stores a set of instructions for wireless communication by a UE. The set of instructions, when executed by one or more processors of the UE, may cause the UE to receive, from a network node, configuration information that indicates a configuration type for wireless communications during one or more SBFD time intervals and one or more non-SBFD time intervals. The set of instructions, when executed by one or more processors of the UE, may cause the UE to receive, from the network node, control information that schedules a set of uplink messages. The set of instructions, when executed by one or more processors of the UE, may cause the UE to transmit, to the network node, a first uplink message from the set of uplink messages in accordance with the first uplink message being valid, wherein the first uplink message is valid in accordance with being scheduled during a valid symbol-type and based at least in part on the configuration type.

Some aspects described herein relate to a non-transitory computer-readable medium that stores a set of instructions for wireless communication by a network node. The set of instructions, when executed by one or more processors of the network node, may cause the network node to transmit, to a UE, configuration information that indicates a configuration type for wireless communications during one or more SBFD time intervals and one or more non-SBFD time intervals. The set of instructions, when executed by one or more processors of the network node, may cause the network node to transmit, to the UE, control information that schedules a set of uplink messages. The set of instructions, when executed by one or more processors of the network node, may cause the network node to receive, from the UE, a first uplink message from the set of uplink messages in accordance with the first uplink message being valid, wherein the first uplink message is valid in accordance with being scheduled during a valid symbol-type and based at least in part on the configuration type.

Some aspects described herein relate to an apparatus for wireless communication. The apparatus may include means for receiving, from a network node, configuration information that indicates a configuration type for wireless communications during one or more SBFD time intervals and one or more non-SBFD time intervals. The apparatus may include means for receiving, from the network node, control information that schedules a set of uplink messages. The apparatus may include means for transmitting, to the network node, a first uplink message from the set of uplink messages in accordance with the first uplink message being valid, wherein the first uplink message is valid in accordance with being scheduled during a valid symbol-type and based at least in part on the configuration type.

Some aspects described herein relate to an apparatus for wireless communication. The apparatus may include means for transmitting, to a UE, configuration information that indicates a configuration type for wireless communications during one or more SBFD time intervals and one or more non-SBFD time intervals. The apparatus may include means for transmitting, to the UE, control information that schedules a set of uplink messages. The apparatus may include means for receiving, from the UE, a first uplink message from the set of uplink messages in accordance with the first uplink message being valid, wherein the first uplink message is valid in accordance with being scheduled during a valid symbol-type and based at least in part on the configuration type.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating examples of full-duplex communication in a wireless network.

FIG. 4 is a diagram illustrating an example of sub-band full duplex (SBFD) activation.

FIG. 5 is a diagram illustrating an example of multiple types of configurations for SBFD operation.

FIGS. 6 through 8 are diagrams illustrating examples associated with uplink message validation and hybrid automative repeat request process identifier incrementation during full-duplex operations.

FIGS. 9 through 11 are diagrams illustrating examples associated with an uplink message validation for multiple uplink messages scheduled by downlink control information format 0_1 during full-duplex operations.

FIG. 12 is a diagram illustrating an example associated with signaling that enables multi-uplink transmission validation during full-duplex operations.

FIG. 13 is a diagram illustrating an example process performed, for example, at a user equipment (UE) or an apparatus of a UE.

FIG. 14 is a diagram illustrating an example process performed, for example, at a network node or an apparatus of a network node.

FIG. 15 is a diagram of an example apparatus for wireless communication.

FIG. 16 is a diagram of an example apparatus for wireless communication.

### DETAILED DESCRIPTION

In some examples, a network node and a user equipment (UE) may communicate uplink and downlink messages in accordance with a subband full-duplex (SBFD) configuration. For example, the SBFD configuration may enable the network node to concurrently transmit downlink messages and receive uplink messages within the same time interval (e.g., time slot), but in different frequency subbands. For example, when a system operates in an SBFD configuration, one (or more) subband(s) may be associated with downlink transmissions and one (or more) other subband(s) may be associated with uplink transmissions within the same time interval. The SBFD configuration may include one or more SBFD time intervals and one or more non-SBFD time intervals (e.g., one or more downlink time intervals, uplink time intervals, or flexible time intervals). For example, SBFD time intervals may be associated with a frequency band that includes one or more uplink frequency subbands allocated for UE transmissions and includes one or more downlink frequency subbands allocated for network transmissions. The non-SBFD time intervals may include time intervals where the frequency band is associated with either downlink or uplink. For example, “downlink time intervals” may refer to time intervals where the frequency band is configured with downlink resources to enable downlink transmissions, and “uplink time intervals” may refer to time intervals where the frequency band is configured with uplink resources to enable uplink transmissions. Additionally, flexible time intervals may allow dynamic switching between uplink and downlink transmission modes based on network scheduling decisions (e.g., adapting to traffic demand and interference conditions). For example, the network node may dynamically configure a flexible time interval to be either an uplink time interval or a downlink time interval. In some examples, the term “time interval” as used herein may refer to one or more symbols, one or more mini-slots, one or more sub-slots, or one or more slots.

In some examples, the SBFD configuration may indicate to the UE a first configuration type or a second configuration type for SBFD operations. For example, the first configuration type may enable the UE to transmit uplink transmissions during one of SBFD time intervals or non-SBFD time intervals. The second configuration type may enable the UE to transmit uplink transmissions during both SBFD time intervals and non-SBFD time intervals.

In some examples, the network node may transmit, and the UE may receive, control information that schedules multiple uplink messages for transmission from the UE during a time division duplex (TDD) operation. For example, the control information may be control information, such as downlink control information (DCI), that schedules multiple physical uplink shared channel (PUSCH) transmissions in non-SBFD time intervals. Accordingly, the UE may be configured or enabled to determine whether the multiple uplink messages are valid for transmission in accordance with TDD operations. However, the UE may not be aware of how to handle multiple uplink messages scheduled by a single DCI during a full-duplex operation. For example, if a PUSCH transmission is scheduled during one or more SBFD symbols (i.e., one or more symbols within an SBFD time interval) that overlap with downlink symbols or reference signals (e.g., a synchronization signal block (SSB)), then the UE may be unaware of how to handle conflict resolution, which may increase miscommunication between the network node and UE, increase interference, and increase a likelihood of dropped wireless messages.

Additionally, a single DCI that schedules multiple PUSCH transmissions may indicate a hybrid automatic repeat request (HARQ) process identifier (ID). During TDD operations, the UE may be configured or enabled to provide and associate the HARQ process ID in the DCI with the first PUSCH not overlapping with downlink symbols or SSB symbols. In some examples, the UE may increment the HARQ process ID for each subsequent PUSCH scheduled by the single DCI. However, the UE may not be aware of rules for HARQ process ID management during full-duplex operations, which poses challenges for ensuring reliable communication and efficient use of radio resources. Without clear rules for HARQ process ID management in SBFD operations, there is a risk of suboptimal performance, including potential symbol overlap issues that could lead to transmission errors, reduced data throughput, and degraded overall system performance.

Various aspects relate generally to improving multi-uplink message scheduling and transmission in wireless communications involving SBFD and non-SBFD time intervals. Some aspects more specifically relate to a UE receiving, from a network node, configuration information that indicates a configuration type for wireless communications during SBFD and non-SBFD time intervals, as well as a single DCI that schedules a set of uplink messages. Accordingly, the UE may transmit a first uplink message from the set of uplink messages, where the first uplink message may be valid for transmission based on being scheduled during a valid symbol-type and based on the configuration type associated with SBFD operations. In some aspects, the UE may handle HARQ process IDs in a manner that correlates with the configuration type and whether the first uplink message is scheduled during SBFD or non-SBFD symbols. Such a process may ensure that the first uplink message is valid and associated with the first HARQ process identifier based on timing and non-overlap with SSB transmissions. The UE may manage subsequent uplink messages similarly, with HARQ process identifiers being incremented accordingly for each valid uplink message in the set.

Particular aspects of the subject matter described in this disclosure can be implemented to realize one or more of the following potential technical advantages. By managing HARQ process identifiers in relation to the configuration type and symbol-type scheduling, the described techniques can be used to optimize uplink transmission scheduling, enhance spectral efficiency, and reduce the risk of collision with downlink transmissions or SSBs, which could otherwise lead to transmission errors or reduced data throughput. This approach ensures more efficient use of radio resources and minimizes the occurrence of retransmissions, thereby conserving network resources. Further, the network node can benefit from a consistent procedure of scheduling and receiving uplink messages from the UE that is tailored to the dynamic nature of SBFD and non-SBFD intervals. Accordingly, the techniques described herein may enable the network node to manage air interface resources more effectively and to optimize the allocation of radio resources, leading to improved spectral efficiency and system capacity. Moreover, a UE’s ability to determine the validity of uplink messages based on the configuration type and the symbol-type scheduling allows for enhanced adaptability to rapidly changing network conditions. Accordingly, the UE may execute real-time transmission decisions that conserve processing and memory resources, reduce latency, and align with network protocols, ultimately contributing to a more streamlined and resource-efficient wireless communication system.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

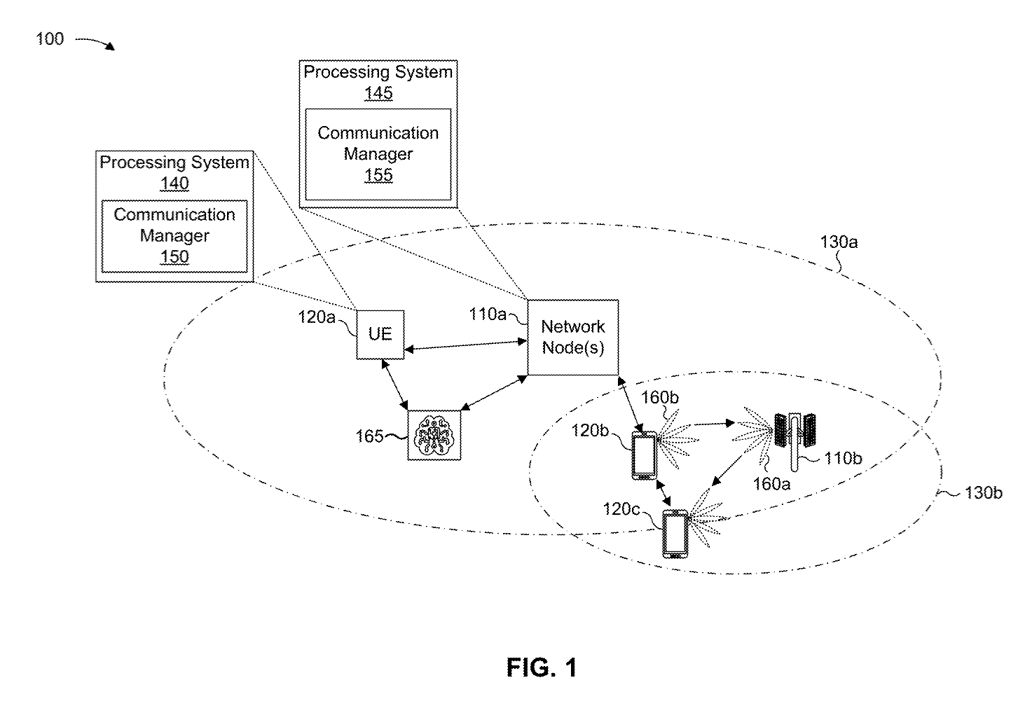

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receivingmultiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 or UEs 120 may generally increase the capacity of the network and the radio access link. In some examples, full-duplex operation may involve a frequency division duplex (FDD) scheme, in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

In some aspects, the UE 120 may include a communication manager 150. As described in more detail elsewhere herein, the communication manager 150 may receive, from a network node, configuration information that indicates a configuration type for wireless communications during one or more SBFD time intervals and one or more non-SBFD time intervals; receive, from the network node, control information that schedules a set of uplink messages; and transmit, to the network node, a first uplink message from the set of uplink messages in accordance with the first uplink message being valid, wherein the first uplink message is valid in accordance with being scheduled during a valid symbol-type and based at least in part on the configuration type. Additionally, or alternatively, the communication manager 150 may perform one or more other operations described herein.

In some aspects, the network node 110 may include a communication manager 155. As described in more detail elsewhere herein, the communication manager 155 may transmit, to a UE, configuration information that indicates a configuration type for wireless communications during one or more SBFD time intervals and one or more non-SBFD time intervals; transmit, to the UE, control information that schedules a set of uplink messages; and receive, from the UE, a first uplink message from the set of uplink messages in accordance with the first uplink message being valid, wherein the first uplink message is valid in accordance with being scheduled during a valid symbol-type and based at least in part on the configuration type. Additionally, or alternatively, the communication manager 155 may perform one or more other operations described herein.

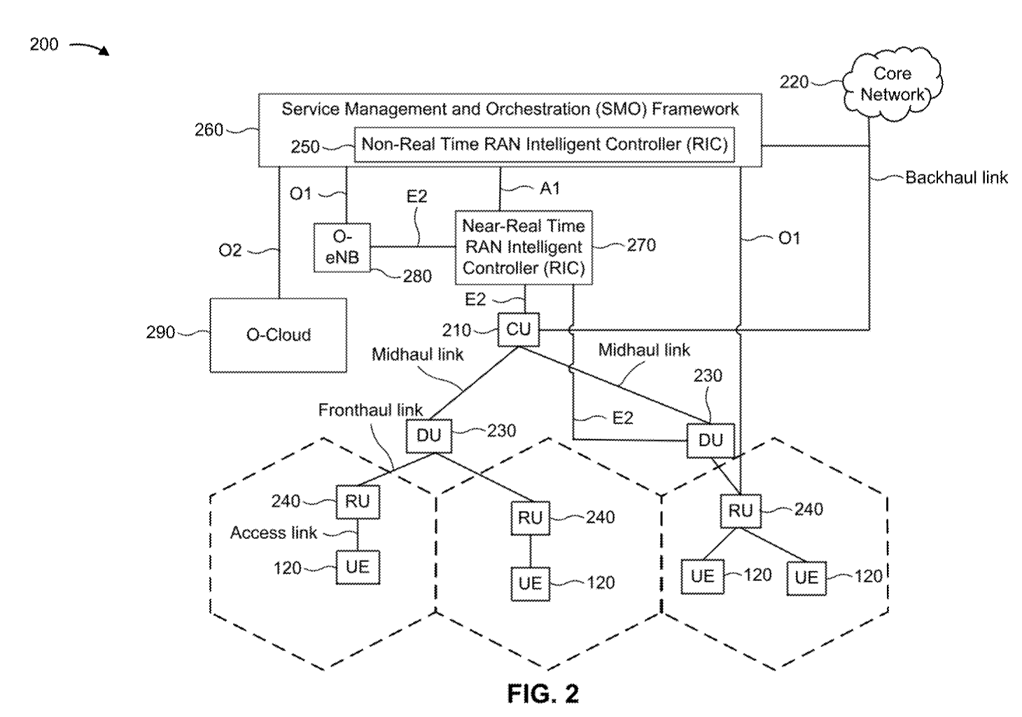

FIG. 2 is a diagram illustrating an example disaggregated network node architecture 200. One or more components of the example disaggregated network node architecture 200 may be, may include, or may be included in one or more network nodes (such as one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

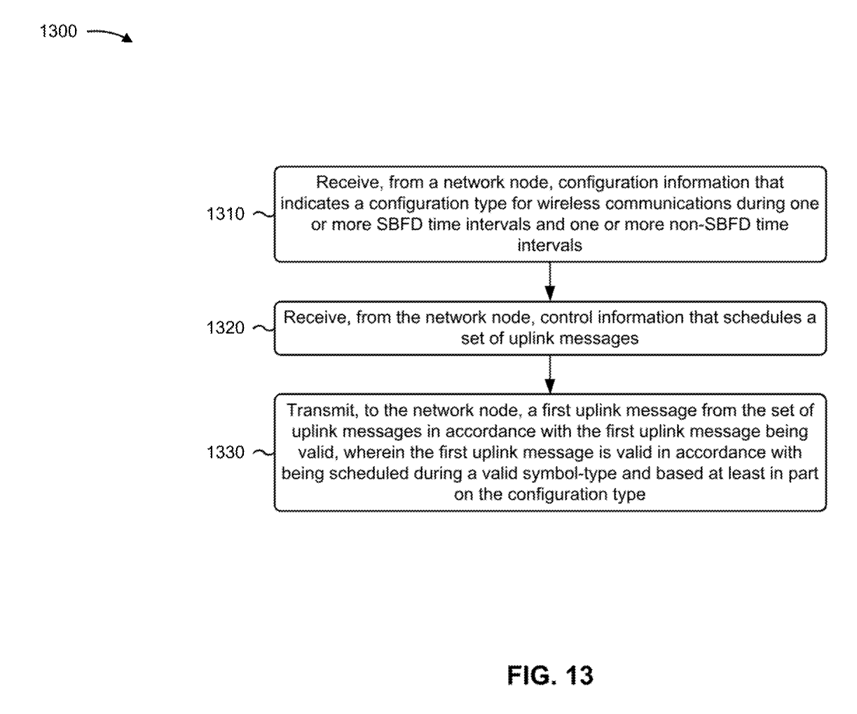

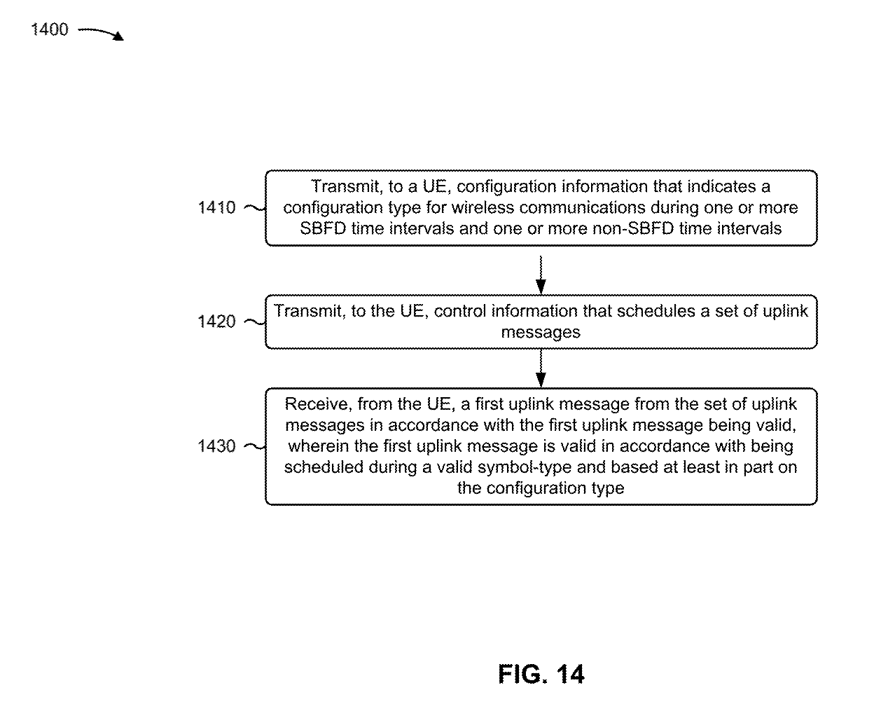

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with multi-uplink transmission validation during full-duplex operations, as described in more detail elsewhere herein. For example, the processing system 145 of the network node 110, the processing system 140 of the UE 120, the CU 210, the DU 230, or the RU 240 may perform or direct operations of, for example, process 1300 of FIG. 13, process 1400 of FIG. 14, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1300 of FIG. 13, process 1400 of FIG. 14, or other processes as described herein. In some examples, executing instructions may include running the instructions, converting the instructions, compiling the instructions, or interpreting the instructions, among other examples.

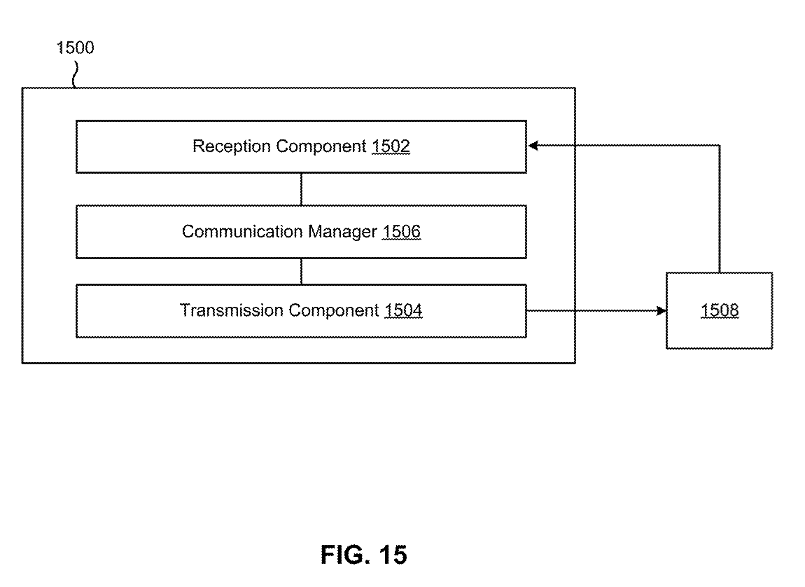

In some aspects, the UE 120 includes means for receiving, from a network node, configuration information that indicates a configuration type for wireless communications during one or more SBFD time intervals and one or more non-SBFD time intervals; means for receiving, from the network node, control information that schedules a set of uplink messages; or means for transmitting, to the network node, a first uplink message from the set of uplink messages in accordance with the first uplink message being valid, wherein the first uplink message is valid in accordance with being scheduled during a valid symbol-type and based at least in part on the configuration type. The means for the UE 120 to perform operations described herein may include, for example, one or more of communication manager 150, processing system 140, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

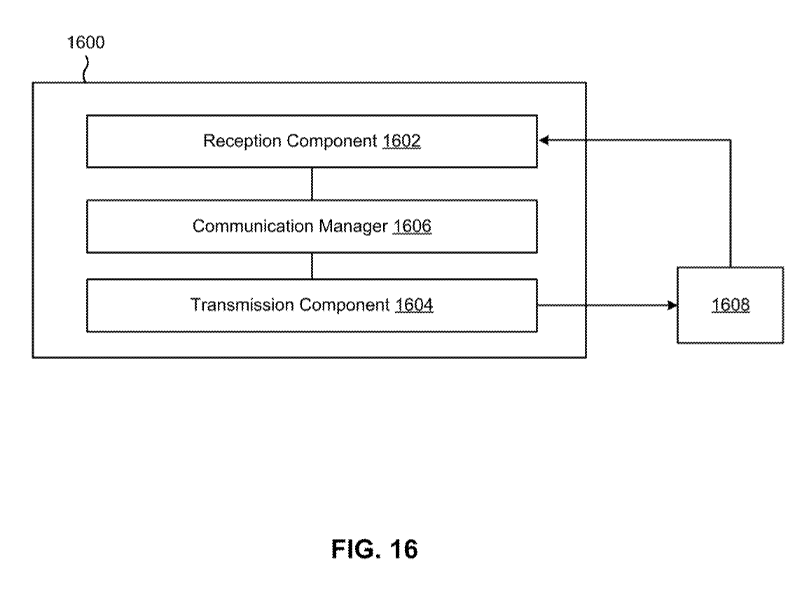

In some aspects, the network node 110 includes means for transmitting, to a UE, configuration information that indicates a configuration type for wireless communications during one or more SBFD time intervals and one or more non-SBFD time intervals; means for transmitting, to the UE, control information that schedules a set of uplink messages; or means for receiving, from the UE, a first uplink message from the set of uplink messages in accordance with the first uplink message being valid, wherein the first uplink message is valid in accordance with being scheduled during a valid symbol-type and based at least in part on the configuration type. The means for the network node 110 to perform operations described herein may include, for example, one or more of communication manager 155, processing system 145, a radio, one or more RF chains, one or more transceivers, one or more antennas, one or more modems, a reception component (for example, reception component 1602 depicted and described in connection with FIG. 16), or a transmission component (for example, transmission component 1604 depicted and described in connection with FIG. 16), among other examples.

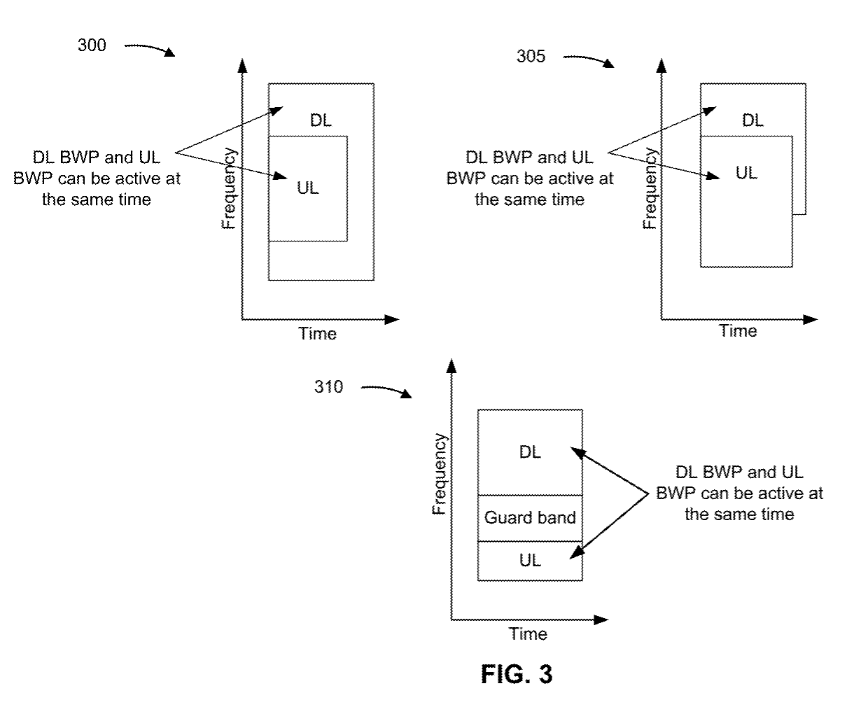

FIG. 3 is a diagram illustrating examples 300, 305, and 310 of full-duplex communication in a wireless network. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 3, examples 300 and 305 show examples of in-band full-duplex (IBFD) communication. In IBFD, a UE may transmit an uplink communication to a network node and receive a downlink communication from the network node on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of sub-band full-duplex (SBFD) communication, which may also be referred to as “sub-band frequency division duplex (SBFDD)” or “flexible duplex.” In SBFD, a UE may transmit an uplink communication to a network node and receive a downlink communication from the network node at the same time, but on different (i.e., non-overlapping) frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As indicated above, FIG. 3 is provided as an example. Other examples may differ from what is described with respect to FIG. 3.

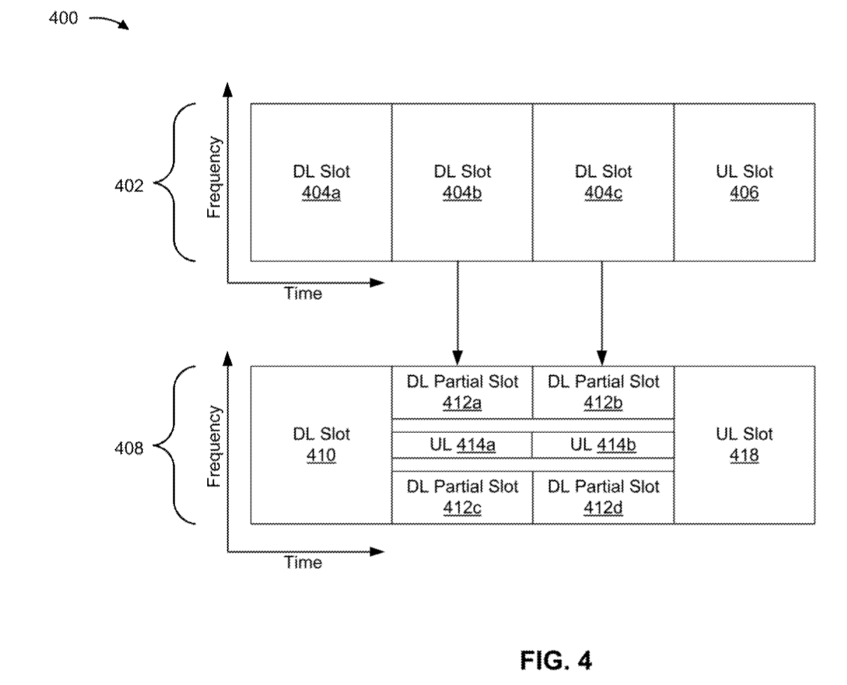

FIG. 4 is a diagram illustrating an example 400 of sub-band full duplex (SBFD) activation. As shown in FIG. 4, example 400 includes a first configuration 402. In some aspects, the first configuration 402 may indicate a first slot format pattern (sometimes called a TDD pattern) associated with a half-duplex mode or a full-duplex mode. The first slot format pattern may include a quantity of downlink slots (e.g., three downlink slots 404a, 404b, and 404c, as shown), a quantity of flexible slots (not shown), and/or a quantity of uplink slots (e.g., one uplink slot 406, as shown). The first slot format pattern may repeat over time. In some aspects, a network node 110 may indicate the first slot format pattern to a UE 120 using one or more slot format indicators. A slot format indicator, for a slot, may indicate whether that slot is an uplink slot, a downlink slot, or a flexible slot, among other examples.

A network node 110 may instruct (e.g., using an indication, such as a radio resource control (RRC) message, a medium access control (MAC) control element (CE) (MAC-CE), or DCI) a UE 120 to switch from the first configuration 402 to a second configuration, e.g., SBFD configuration 408. As an alternative, the UE 120 may indicate to the network node 110 that the UE 120 is switching from the first configuration 402 to the second configuration, e.g., the SBFD configuration 408. The SBFD configuration 408 may indicate a second slot format pattern that repeats over time, similar to the first slot format pattern. In any of the aspects described above, the UE 120 may switch from the first configuration 402 to the SBFD configuration 408 during a time period (e.g., a quantity of symbols or an amount of time (e.g., in ms)) based at least in part on an indication received from the network node 110 (e.g., before switching back to the first configuration 402). During that time period, the UE 120 may communicate using the second slot format pattern, and then may revert to using the first slot format pattern after the end of the time period. The time period may be indicated by the network node 110 (e.g., in the instruction to switch from the first configuration 402 to the SBFD configuration 408, as described above) or based at least in part on a programmed or otherwise preconfigured rule. For example, the rule may be based at least in part on a table (e.g., defined in 3GPP specifications or another wireless communication standard) that associates different sub-carrier spacings (SCSs) or numerologies (e.g., represented by µ and associated with corresponding SCSs) with corresponding time periods for switching configurations.

In example 400, the second slot format pattern includes two SBFD slots in place of what were downlink slots in the first slot format pattern. In example 400, each SBFD slot includes one or more partial slots (e.g., a portion or sub-band of a frequency allocated for use by the network node 110 and the UE 120) for downlink (e.g., partial slots 412a, 412b, 412c, and 412d, as shown) and one or more partial slots for uplink (e.g., partial slots 414a and 414b, as shown). Accordingly, the UE 120 may operate using the second slot format pattern to transmit an uplink communication in an earlier slot (e.g., the second slot in sequence, shown as partial UL slot 414a) as compared to using the first slot format pattern (e.g., the fourth slot in sequence, shown as UL slot 406). Other examples may include additional or alternative changes. For example, the SBFD configuration 408 may indicate an SBFD slot in place of what was an uplink slot in the first configuration 402 (e.g., UL slot 406). In another example, the SBFD configuration 408 may indicate a downlink slot or an uplink slot in place of what was an SBFD slot in another configuration (not shown in FIG. 4). In yet another example, the SBFD configuration 408 may indicate a downlink slot or an uplink slot in place of what was an uplink slot or a downlink slot, respectively, in the first configuration 402. An “SBFD slot” may refer to a slot in which an SBFD format is used. An SBFD format may include a slot format in which full duplex communication is supported (e.g., for both uplink and downlink communications), with one or more frequencies used for an uplink portion of the slot that do not overlap with one or more frequencies used for a downlink portion of the slot. The one or more frequencies used for the uplink portion may be separated from the one more frequencies used for the downlink by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 4). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using an FD mode in one or more slots based at least in part on the one or more slots having the SBFD format. A slot may support the SBFD mode if an UL BWP and a DL BWP are permitted to be or are simultaneously active in the slot in an SBFD fashion (e.g., with guard band separation).

By switching from the first configuration 402 to the SBFD configuration 408, the network node 110 and the UE 120 may experience increased quality or reliability of communications. For example, the network node 110 and the UE 120 may experience increased throughput (e.g., using a full-duplex mode), reduced latency (e.g., the UE 120 may be able to transmit an uplink or a downlink communication sooner using the SBFD configuration 408 rather than the first configuration 402), and increased network resource utilization (e.g., by using both the DL BWP and the UL BWP simultaneously instead of only the DL BWP or the UL BWP).

As indicated above, FIG. 4 is provided as an example. Other examples may differ from what is described with respect to FIG. 4.

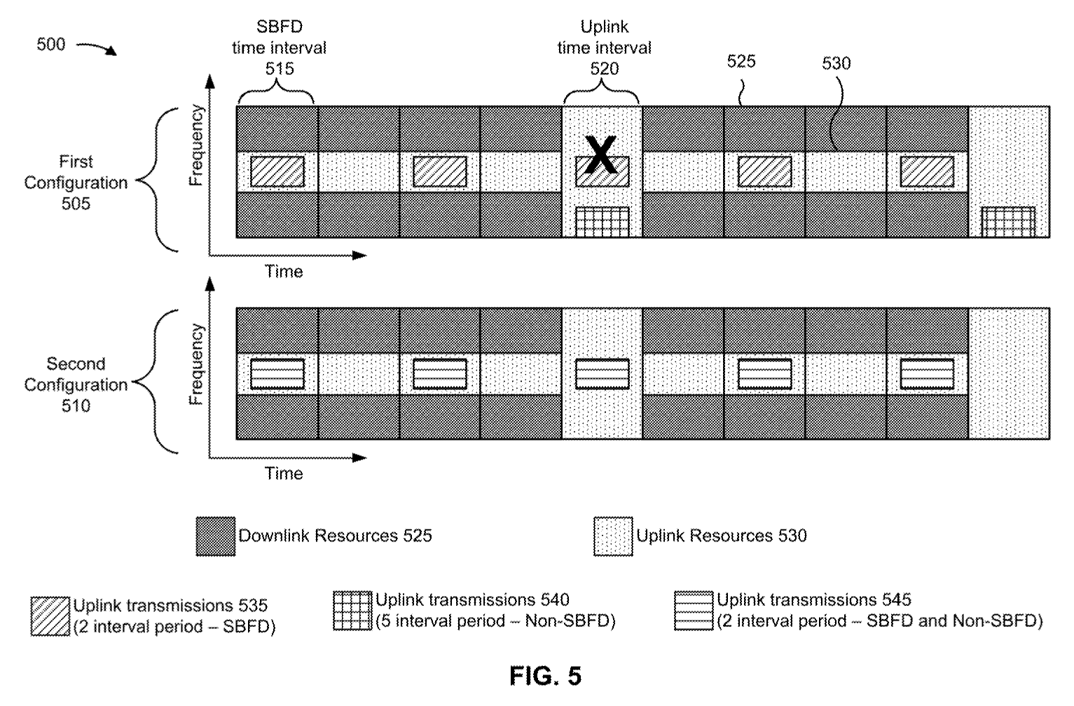

FIG. 5 is a diagram illustrating an example 500 of multiple types of configurations for SBFD operation. In some instances, example 500 may implement or be implemented by one or more aspects of FIGS. 1 through 4. For instance, FIG. 5 illustrates wireless communications between the network node 110 and the UE 120.

FIG. 5 illustrates one or more SBFD time intervals 515, which may be examples of SBFD time intervals described with reference to FIG. 4. For example, the SBFD time intervals 515 may include two downlink frequency subbands (e.g., for downlink transmissions by the network node 110) separated in the frequency domain by an uplink frequency subband (e.g., for uplink transmissions by the UE 120). For example, the downlink frequency subbands may span a set of downlink resources 525 and the uplink frequency subband may span a set of uplink resources 530. Accordingly, during the SBFD time interval 515, the network node 110 may concurrently transmit (to multiple UEs 120) one or more downlink transmissions and receive (from one or more UE 120s) one or more uplink transmissions. In some examples, an SBFD time interval 515 may include any number of uplink frequency subbands and any number of downlink frequency subbands in any uplink/downlink frequency subband pattern. In some examples, an SBFD time interval 515 may span one or more symbols, one or more sub-slots, one or more mini-slots, or one or more slots.

FIG. 5 further illustrates one or more uplink time intervals 520, which may be examples of the uplink time intervals described with reference to FIG. 4 (e.g., uplink slot 406 and 418). For example, the uplink time intervals 520 may span a frequency bandwidth that includes uplink resources 530. In other words, the uplink time intervals 520 may be TDD time intervals configured for the UE 120 to transmit one or more uplink transmissions. In some examples, an uplink time interval 520 may span one or more symbols, one or more sub-slots, one or more mini-slots, or one or more slots. In some examples, “TDD time intervals” may be referred to elsewhere herein as “non-SBFD time intervals.”

In some examples, the UE 120 may be an SBFD-aware UE 120. In other words, the UE 120 may be aware of the one or more downlink subbands and the one or more uplink subbands of the SBFD time intervals. In accordance with the UE 120 being SBFD-aware, the UE 120 may transmit uplink transmissions or receive downlink transmissions across one or more of SBFD symbols and non-SBFD symbols across multiple time intervals. In some examples, a given uplink transmission or downlink transmission may be within a single time interval that includes exclusively SBFD symbols or exclusively non-SBFD symbols.

In some examples, the network node 110 may transmit, and the UE 120 may receive, one of a first configuration 505 or a second configuration 510 associated with SBFD operations and non-SBFD operations. For example, as described elsewhere herein, the first configuration 505 may enable the UE 120 to transmit uplink transmissions during one of the SBFD time intervals 515 or non-SBFD time intervals and the second configuration 510 may enable the UE 120 to transmit uplink transmissions during both SBFD time intervals and non-SBFD time intervals. In some examples, the network node 110 may indicate one of the first configuration 505 or the second configuration 510 as part of an SBFD configuration (e.g., the SBFD configuration 408 described with reference to FIG. 4). For example, the network node 110 may transmit the SBFD configuration via one or more of RRC signaling, MAC signaling (e.g., via one or more MAC-CEs), or DCI signaling.

If the UE 120 operates in accordance with the first configuration 505, then wireless transmissions and receptions at the UE 120 may occur exclusively during SBFD time intervals (e.g., symbols) or exclusively during non-SBFD time intervals (e.g., symbols). For example, as shown with reference to the first configuration 505, the UE 120 may transmit multiple uplink transmissions 535 in accordance with a period of two time intervals. In an example, a time interval as shown in FIG. 5 may be a symbol, which is used for illustration below. It should be understood that the time interval is not limited to a symbol, as already explained above. The multiple uplink transmissions 540 may, in one example, be configured exclusively for SBFD symbols (e.g., in accordance with the first configuration 505). Accordingly, the UE 120 may drop one or more uplink transmissions 535 that span non-SBFD symbols (e.g., drop uplink transmissions 535 that are during uplink time intervals 520). Further, as shown with reference to the first configuration 505, the UE 120 may transmit multiple uplink transmissions 540 in accordance with a period of five time intervals. Additionally, the multiple uplink transmissions 535 may be configured for exclusively non-SBFD symbols (e.g., in accordance with the first configuration 505). Accordingly, the UE 120 may drop one or more uplink transmissions that span SBFD symbols (e.g., drop uplink transmissions that are during SBFD time intervals 515). In some examples, operations in accordance with the first configuration 505 may reduce complexity associated with differences in interference levels between SBFD and non-SBFD time intervals. Therefore, by transmitting uplink transmissions via exclusively SBFD symbols or via exclusively non-SBFD symbols, the UE 120 may use a same set of power control parameters across multiple uplink transmissions.

If the UE 120 operates in accordance with the second configuration 510, then wireless transmissions and receptions at the UE 120 may occur during both SBFD symbols and non-SBFD symbols. For example, as shown with reference to the second configuration 510, the UE 120 may transmit multiple uplink transmissions 545 in accordance with a period of two time intervals. Additionally, the multiple uplink transmissions 545 may be configured for transmission during both SBFD symbols and non-SBFD symbols (e.g., in accordance with the second configuration 510). In some examples, operations in accordance with the second configuration 510 may increase data throughput and reduce latency based on reducing a number of uplink transmissions that a UE 120 may drop.

In some examples, the network node 110 may indicate, to the UE 120, the second configuration 510 on a per bandwidth part (BWP) basis. For example, if the network node 110 indicates the second configuration 510 for a downlink BWP, then the UE 120 may operate in accordance with the second configuration 510 for one or more downlink messages (e.g., at least PDSCHs) within the downlink BWP. If the network node 110 indicates the second configuration 510 for an uplink BWP, then the UE 120 may operate in accordance with the second configuration 510 for one or more uplink messages (e.g., at least PUCCHs and PUSCHs) within the uplink BWP. In some examples, the UE 120 may operate in accordance with the first configuration 505 for SRS transmissions (e.g., even if the second configuration 510 is configured). In some examples, the first configuration 505 may be a default configuration for the UE 120. That is, the second configuration 510 may be based on the UE 120 supporting the second configuration 510 (e.g., based on a UE 120 capability).

As indicated above, FIG. 5 is provided as an example. Other examples may differ from what is described with respect to FIG. 5.

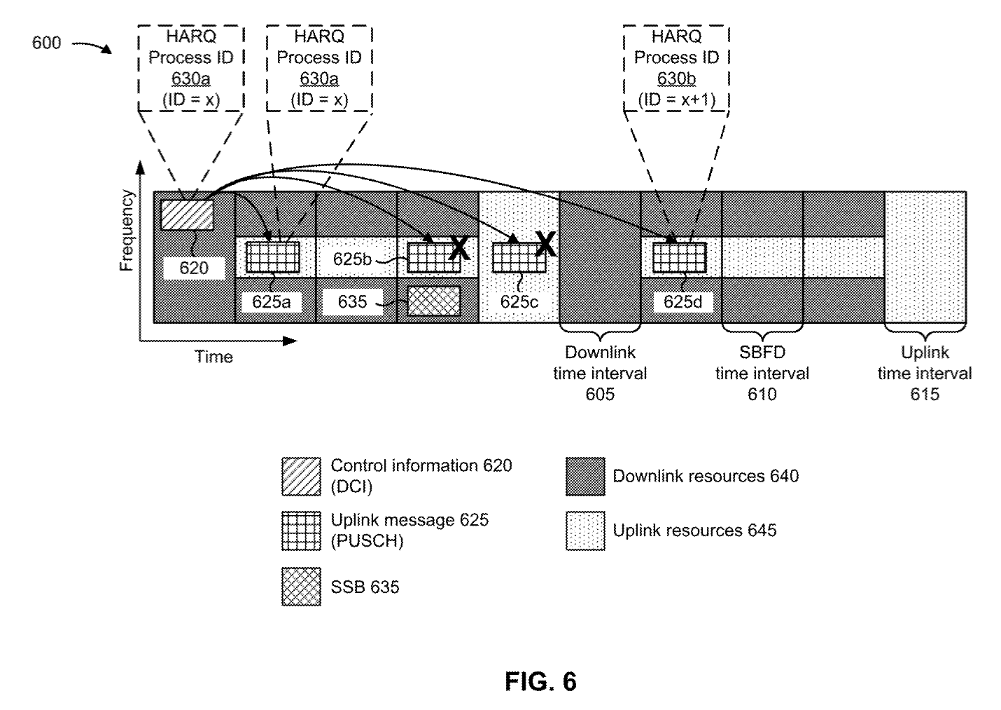

FIG. 6 is a diagram illustrating example 600 associated with uplink message validation and HARQ process ID incrementation during full-duplex operations. In some instances, example 600 may implement or be implemented by one or more aspects of FIGS. 1 through 5. For instance, FIG. 6 may illustrate a wireless communications timeline between the network node 110 and the UE 120. Additionally, SBFD time intervals 610 and uplink time intervals 615 may be respective examples of SBFD time intervals 515 and uplink time intervals 520, as described with reference to FIG. 5. Additionally, downlink resources 640 and uplink resources 645 may be respective examples of downlink resources 525 and uplink resources 530, as described with reference to FIG. 5. Additionally, the techniques described with reference to example 600 may be for scenarios where the UE 120 is operating in accordance with the first configuration 505 and the valid symbol-type is SBFD symbols (e.g., based on a first transmission occasion including SBFD symbols).

FIG. 6 illustrates one or more downlink time intervals 605, which may be examples of the downlink time intervals described with reference to FIG. 4 (e.g., downlink slots 404a, 404b, 404c, and 410). For example, the downlink time intervals 605 may span a frequency bandwidth that includes downlink resources 640. In other words, the downlink time intervals 605 may be TDD time intervals configured for the network node 110 to transmit one or more downlink transmissions. In some examples, a downlink time interval 605 may span one or more symbols, one or more sub-slots, one or more mini-slots, or one or more slots. In some examples, the downlink time intervals 605 and the uplink time intervals 615 may be referred to elsewhere herein as “non-SBFD time intervals.”

In some examples, the downlink time intervals 605, the SBFD time intervals 610, and the uplink time intervals 615 may be part of an SBFD configuration (e.g., the SBFD configuration 408) that includes one or more SBFD time intervals and one or more non-SBFD time intervals. In some examples, the SBFD configuration may be associated with a time interval format pattern that repeats over time. For instance, in example 600, the time interval format pattern may start with a downlink time interval 605, followed by three consecutive SBFD time intervals 610, and end with an uplink time interval 615 (e.g., and repeat over time). In some other examples, the time interval format pattern may include any number of downlink time intervals 605, any number of SBFD time intervals 610, and any number of uplink time intervals 615, in any order.

As shown in FIG. 6, the network node 110 may transmit, and the UE 120 may receive, control information 620 that schedules a set of uplink messages 625 (e.g., uplink message 625a, 625b, 625c, and 625d) for transmission by the UE 120. For example, the control information 620 may be a single DCI that schedules multiple PUSCH messages. The control information 620 includes scheduling information for the set of uplink messages 625. For example, the control information 620 may indicate one or more time resources (e.g., time division resource allocation (TDRA) information), one or more frequency resources (e.g., frequency division resource allocation (FDRA) information), or other parameters for the set of uplink messages 625.

As described herein, the uplink messages 625 may be PUSCH transmissions that carry user data, such as internet traffic or voice calls. In some examples, the uplink messages 625 may include one or more SPS-PUSCHs used for periodic data transmissions (such as voice over IP (VoIP) or real-time video streaming), where the scheduling information may be provided by the control information 620 and reused for multiple uplink transmissions, reducing control signaling overhead. In some examples, the uplink messages 625 may include uplink control information (UCI), which may indicate one or more of HARQ acknowledgments, CSI, or scheduling requests (SRs), which may enable the UE 120 to provide feedback and request resources from the network node 110. In some examples, the uplink messages 625 may carry random access responses (RARs) during an initial access procedure, allowing the UE 120 to establish a connection with the network. In some other examples, the uplink messages 625 may be any other type of uplink message described elsewhere herein.

As shown in FIG. 6, the control information 620 may indicate a HARQ process ID 630a. For example, a HARQ process ID may be a unique identifier used in wireless communication systems to manage the error correction and retransmission process for data packets transmitted between the UE 120 and the network node 110. As described elsewhere herein, HARQ processes may include forward error correction and automatic repeat request techniques to enhance the reliability of a data transmission. For instance, when a data packet (e.g., an uplink message 625) is transmitted, the data packet may be assigned a HARQ process ID, which allows the UE 120 and the network node 110 to track and manage a status of the data packet independently of other transmissions. If the network node 110 detects errors in a data packet received from the UE, the network node 110 may transmit a negative acknowledgment (NACK) to the UE 120, prompting the UE 120 to retransmit the data packet using the same HARQ process ID. Conversely, if the network node 110 correctly receives the data packet, the network node 110 may transmit a positive acknowledgment (ACK), and the HARQ process associated with the data packet may be considered complete. By using multiple HARQ processes with distinct IDs, the network node 110 and the UE 120 may handle multiple data packets concurrently, ensuring efficient use of resources and maintaining high data throughput while minimizing latency and packet loss. In some examples, the UE 120 may be configured (e.g., via RRC signaling from the network node 110) with a parameter that indicates a total number of concurrent HARQ processes available for PUSCH transmissions (e.g., nrofHARQ-ProcessesForPUSCH). If, however, the UE 120 is not configured with a total number of concurrent HARQ processes available for PUSCH transmissions, the UE 120 may default to a value of 16 for the total number of concurrent HARQ processes allowed.

In some examples, the control information 620 may indicate a single HARQ process ID, rather than indicating a set of HARQ process IDs respectively associated with the set of uplink messages, to reduce signaling overhead. For example, as shown in FIG. 6, the control information 620 indicates the HARQ process ID 630a (e.g., ID = x, where x is an integer value).

In accordance with the techniques of example 600, if the UE 120 is configured with the first configuration 505 for uplink transmissions per uplink bandwidth part, and the UE 120 is scheduled with multiple uplink messages 625 by the control information 620 (e.g., a single DCI schedules multiple PUSCHs), and an initial or first transmission occasion for the uplink messages 625 is associated with SBFD time intervals (e.g., symbols), then the HARQ process ID 630a indicated by control information 620 applies to a first uplink message 625 scheduled in SBFD time intervals (e.g., symbols) not overlapping with SSB symbols or non-SBFD symbols (e.g., downlink symbols, uplink symbols, or flexible symbols). For instance, as shown in FIG. 6, the uplink message 625a is an earliest uplink message (in time) of the set of uplink messages 625 that is scheduled during SBFD symbols and does not overlap with SSB symbols or non-SBFD symbols. Accordingly, the UE 120 may apply the HARQ process ID 630a to the uplink message 625a. Therefore, the UE 120 may internally use the HARQ process ID 630a to track the HARQ process associated with the uplink message 625a.

Additionally, in accordance with the techniques of example 600, the UE may not increment or apply a HARQ process ID to uplink messages 625 that are scheduled during one or more symbols of a symbol type that is not foreseen for uplink messages 625 (e.g., downlink symbols, uplink symbols, or flexible symbols for example 600) or uplink messages 625 that are scheduled during at least one symbol (indicated by the TDRA information of the control information 620) that is a non-SBFD symbol or an SBFD symbol that overlaps with an SSB symbol. In either case, the UE considers the one or more symbols scheduled as invalid symbols. For instance, as shown in FIG. 6, the uplink message 625b is scheduled during one or more SBFD symbols; however, the one or more SBFD symbols at least partially overlap in time with one or more symbols scheduled for an SSB 635. Therefore, the UE 120 may drop the uplink message 625b and may not apply an incremented HARQ process ID to the uplink message 625b. Additionally, as shown in FIG. 6, the uplink message 625c is scheduled during an uplink time interval 615 that includes one or more non-SBFD symbols (e.g., symbols that are configured only for uplink). Therefore, the UE 120 may drop the uplink message 625c and may not apply an incremented HARQ process ID to the uplink message 625c.

Additionally, as shown in FIG. 6, the uplink message 625d is a next earliest uplink message in time (after the uplink message 625a) that is scheduled during SBFD symbols and does not overlap with SSB symbols or non-SBFD symbols. Accordingly, the UE 120 may apply a HARQ process ID 630b to the uplink message 625d. As shown in FIG. 6, the HARQ process ID 630b may be incremented by one (1) relative to the HARQ process ID 630a (e.g., ID = x+1). Therefore, the UE 120 may internally use the HARQ process ID 630b to track the HARQ process associated with the uplink message 625d. If the control information 620 schedules another uplink message subsequent in time to the uplink message 625d (where the UE 120 determines the subsequent uplink message to be valid for transmission), then the UE 120 may apply another HARQ process ID to the subsequent uplink message that may be incremented by one relative to the HARQ process ID 630b (e.g., ID = x+2).

Accordingly, the techniques of example 600 may enable the UE 120 to validate which of the scheduled set of uplink messages 625 are valid for scenarios where the UE 120 is configured with the first configuration 505 where the valid symbol-type is SBFD symbols. Therefore, the techniques of example 600 may enable the UE 120 to perform uplink message validation and HARQ process ID incrementation during time intervals associated with SBFD operations.

As indicated above, FIG. 6 is provided as an example. Other examples may differ from what is described with respect to FIG. 6.

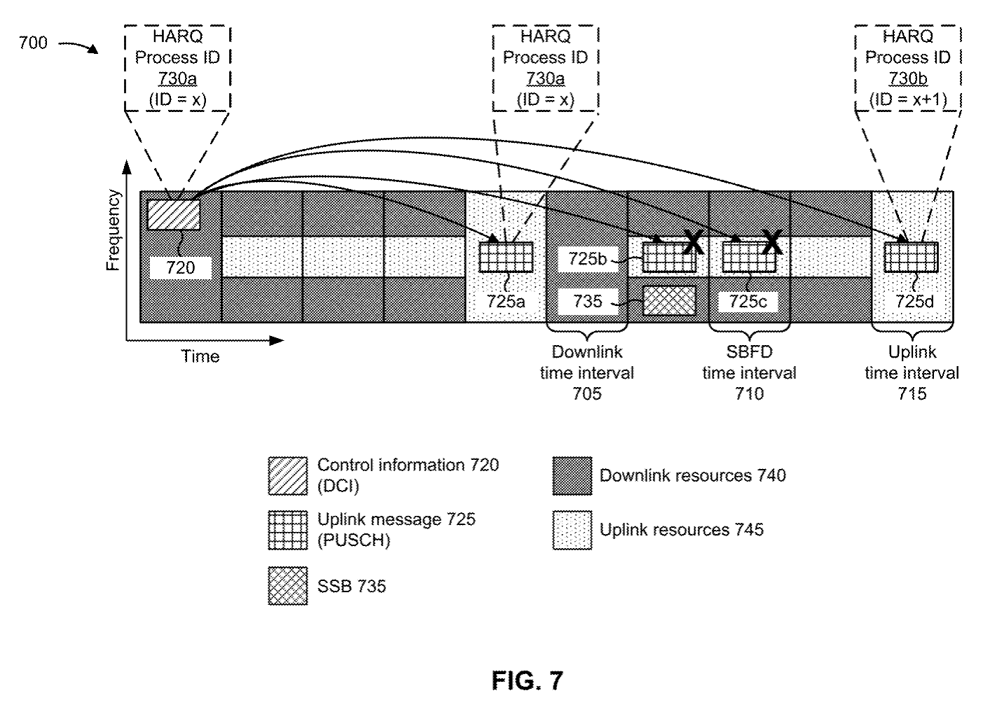

FIG. 7 is a diagram illustrating example 700 associated with uplink message validation and HARQ process ID incrementation during full-duplex operations. In some instances, example 700 may implement or be implemented by one or more aspects of FIGS. 1 through 6. For instance, FIG. 7 may illustrate a wireless communications timeline between the network node 110 and the UE 120. In some examples, downlink time intervals 705, SBFD time intervals 710, and uplink time intervals 715 may be respective examples of the downlink time intervals 605, the SBFD time intervals 610, and the uplink time intervals 615. In other words, example 700 may be associated with a same SBFD configuration as example 600. In some examples, control information 720 may be an example of the control information 620. In some examples, a set of uplink messages 725 (e.g., uplink message 725a, 725b, 725c, and 725d) may be an example of the set of uplink messages 625. In some examples, HARQ process IDs 730 may be examples of the HARQ process IDs 630. In some examples, the SSB 735 may be an example of the SSB 635. In some examples, downlink resources 740 and uplink resources 745 may be respective examples of downlink resources 525 and uplink resources 530. Additionally, the techniques described with reference to example 700 may be for scenarios where the UE 120 is operating in accordance with the first configuration 505 and the valid symbol-type is non-SBFD symbols (e.g., based on a first transmission occasion including non-SBFD symbols).

As shown in FIG. 7, the network node 110 may transmit, and the UE 120 may receive, the control information 720 that schedules a set of uplink messages 725. The control information 720 may include scheduling information for the set of uplink messages 725, as described elsewhere herein. As shown in FIG. 7, the control information 720 may indicate a HARQ process ID 730a (a HARQ process ID is described elsewhere herein). In some examples, the control information 720 may indicate a single HARQ process ID, rather than indicating a set of HARQ process IDs respectively associated with the set of uplink messages, to reduce signaling overhead. For example, as shown in FIG. 7, the control information 720 indicates the HARQ process ID 730a (e.g., ID = x, where x is an integer value).

In accordance with the techniques of example 700, if the UE 120 is configured with the first configuration 505 for uplink transmissions per uplink bandwidth part, and the UE 120 is scheduled with multiple uplink messages 725 by the control information 720 (e.g., a single DCI schedules multiple PUSCHs), and an initial or first transmission occasion for the uplink messages 725 is associated with non-SBFD symbols, then the HARQ process ID 730a indicated by control information 720 applies to a first uplink message 725 scheduled in uplink or flexible symbols not overlapping with SSB symbols, downlink symbols, or SBFD symbols. For instance, as shown in FIG. 7, the uplink message 725a is an earliest uplink message (in time) of the set of uplink messages 725 that is scheduled during uplink or flexible symbols and does not overlap with SSB symbols, downlink symbols, or SBFD symbols. Accordingly, the UE 120 may apply the HARQ process ID 730a to the uplink message 725a. Therefore, the UE 120 may internally use the HARQ process ID 730a to track the HARQ process associated with the uplink message 725a.

Additionally, in accordance with the techniques of example 700, the UE 120 may not increment or apply a HARQ process ID to uplink messages 725 that are scheduled during one or more symbols of an invalid symbol type (e.g., downlink symbols or SBFD symbols for example 700) or uplink messages 725 that are scheduled during at least one symbol (indicated by the TDRA information of the control information 720) that is an SBFD symbol, a downlink symbol, or a symbol scheduled for an SSB transmission. For instance, as shown in FIG. 7, the uplink message 725b is scheduled during one or more SBFD symbols and at least partially overlaps in time with one or more symbols scheduled for the SSB 735. Therefore, the UE 120 may drop the uplink message 725b and may not apply an incremented HARQ process ID to the uplink message 725b. Additionally, as shown in FIG. 7, the uplink message 725c is scheduled during an SBFD time interval 710 that includes one or more SBFD symbols. Therefore, the UE 120 may drop the uplink message 725c and may not apply an incremented HARQ process ID to the uplink message 725c.

Additionally, as shown in FIG. 7, the uplink message 725d is a next earliest uplink message in time (after the uplink message 725a) that is scheduled during uplink or flexible symbols and does not overlap with SSB symbols, downlink symbols, or SBFD symbols. Accordingly, the UE 120 may apply a HARQ process ID 730b to the uplink message 725d. As shown in FIG. 7, the HARQ process ID 730b may be incremented by one (1) relative to the HARQ process ID 730a (e.g., ID = x+1). Therefore, the UE 120 may internally use the HARQ process ID 730b to track the HARQ process associated with the uplink message 725d. If the control information 720 schedules another uplink message subsequent in time to the uplink message 725d (where the UE 120 determines the subsequent uplink message to be valid for transmission), then the UE 120 may apply another HARQ process ID to the subsequent uplink message that may be incremented by one relative to the HARQ process ID 730b (e.g., ID = x+2).

Accordingly, the techniques of example 700 may enable the UE 120 to validate which of the scheduled set of uplink messages 725 are valid for scenarios where the UE 120 is configured with the first configuration 505 where the valid symbol-type is non-SBFD symbols. Therefore, the techniques of example 700 may enable the UE 120 to perform uplink message validation and HARQ process ID incrementation during time intervals associated with SBFD operations.

As indicated above, FIG. 7 is provided as an example. Other examples may differ from what is described with respect to FIG. 7.

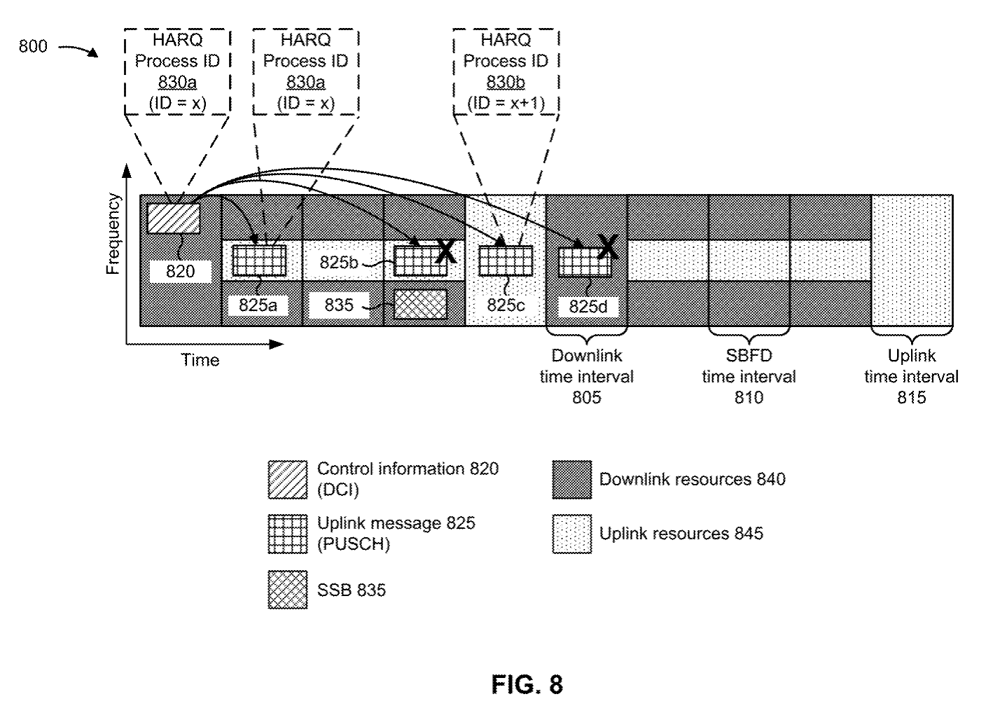

FIG. 8 is a diagram illustrating example 800 associated with uplink message validation and HARQ process ID incrementation during full-duplex operations. In some instances, example 800 may implement or be implemented by one or more aspects of FIGS. 1 through 6. For instance, FIG. 8 may illustrate a wireless communications timeline between the network node 110 and the UE 120. In some examples, downlink time intervals 805, SBFD time intervals 810, and uplink time intervals 815 may be respective examples of the downlink time intervals 605, the SBFD time intervals 610, and the uplink time intervals 615. In other words, example 800 may be associated with a same SBFD configuration as example 600. In some examples, control information 820 may be an example of the control information 620. In some examples, a set of uplink messages 825 (e.g., uplink message 825a, 825b, 825c, and 825d) may be an example of the set of uplink messages 625. In some examples, HARQ process IDs 830 may be examples of the HARQ process IDs 630. In some examples, the SSB 835 may be an example of the SSB 635. In some examples, downlink resources 840 and uplink resources 845 may be respective examples of downlink resources 525 and uplink resources 530. Additionally, the techniques described with reference to example 800 may be for scenarios where the UE 120 is operating in accordance with the second configuration 510 (e.g., the UE 120 is enabled to transmit the uplink messages 825 during both non-SBFD symbols and SBFD symbols).

As shown in FIG. 8, the network node 110 may transmit, and the UE 120 may receive, the control information 820 that schedules a set of uplink messages 825. The control information 820 may include scheduling information for the set of uplink messages 825, as described elsewhere herein. As shown in FIG. 8, the control information 820 may indicate a HARQ process ID 830a. In some examples, the control information 820 may indicate a single HARQ process ID, rather than indicating a set of HARQ process IDs respectively associated with the set of uplink messages, to reduce signaling overhead. For example, as shown in FIG. 8, the control information 820 indicates the HARQ process ID 830a (e.g., ID = x, where x is an integer value).

In accordance with the techniques of example 800, if the UE 120 is configured with the second configuration 510 for uplink transmissions per uplink bandwidth part, and UE 120 is scheduled with multiple uplink messages 825 by the control information 820 (e.g., a single DCI schedules multiple PUSCHs), then the HARQ process ID 830a indicated by control information 820 applies to a first uplink message 825 scheduled in uplink symbols, flexible symbols, or SBFD symbols not overlapping with SSB symbols or downlink symbols (e.g., downlink symbols during a time interval not configured as an SBFD time interval 810). For instance, as shown in FIG. 8, the uplink message 825a is an earliest uplink message (in time) of the set of uplink messages 825 that is scheduled during uplink, flexible, or SBFD symbols and does not overlap with SSB symbols or downlink symbols. Accordingly, the UE 120 may apply the HARQ process ID 830a to the uplink message 825a. Therefore, the UE 120 may internally use the HARQ process ID 830a to track the HARQ process associated with the uplink message 825a.

Additionally, in accordance with the techniques of example 800, the UE 120 may not increment or apply a HARQ process ID to uplink messages 825 that are scheduled during one or more symbols of an invalid symbol type (e.g., downlink symbols for example 800) or uplink messages 825 that are scheduled during at least one symbol (indicated by the TDRA information of the control information 820) that is a downlink symbol or a symbol scheduled for an SSB transmission. For instance, as shown in FIG. 8, the uplink message 825b is scheduled during one or more SBFD symbols; however, the one or more SBFD symbols at least partially overlap in time with one or more symbols scheduled for the SSB 835. Therefore, the UE 120 may drop the uplink message 825b and may not apply an incremented HARQ process ID to the uplink message 825b. Additionally, as shown in FIG. 8, the uplink message 825d is scheduled during a downlink time interval 805 that includes one or more downlink symbols. Therefore, the UE 120 may drop the uplink message 825d and may not apply an incremented HARQ process ID to the uplink message 825d.

Additionally, as shown in FIG. 8, the uplink message 825c is a next earliest uplink message in time (after the uplink message 825a) that is scheduled during uplink, flexible, or SBFD symbols and does not overlap with SSB symbols or downlink symbols. Accordingly, the UE 120 may apply a HARQ process ID 830b to the uplink message 825c. As shown in FIG. 8, the HARQ process ID 830b may be incremented by one (1) relative to the HARQ process ID 830a (e.g., ID = x+1). Therefore, the UE 120 may internally use the HARQ process ID 830b to track the HARQ process associated with the uplink message 825c. If the control information 820 schedules another uplink message subsequent in time to the uplink message 825d (where the UE 120 determines the subsequent uplink message to be valid for transmission), then the UE 120 may apply another HARQ process ID to the subsequent uplink message that may be incremented by one relative to the HARQ process ID 830b (e.g., ID = x+2).

Accordingly, the techniques of example 800 may enable the UE 120 to validate which of the scheduled set of uplink messages 825 are valid for scenarios where the UE 120 is configured with the second configuration 510. Therefore, the techniques of example 800 may enable the UE 120 to perform uplink message validation and HARQ process ID incrementation during time intervals associated with SBFD operations.

As indicated above, FIG. 8 is provided as an example. Other examples may differ from what is described with respect to FIG. 8.

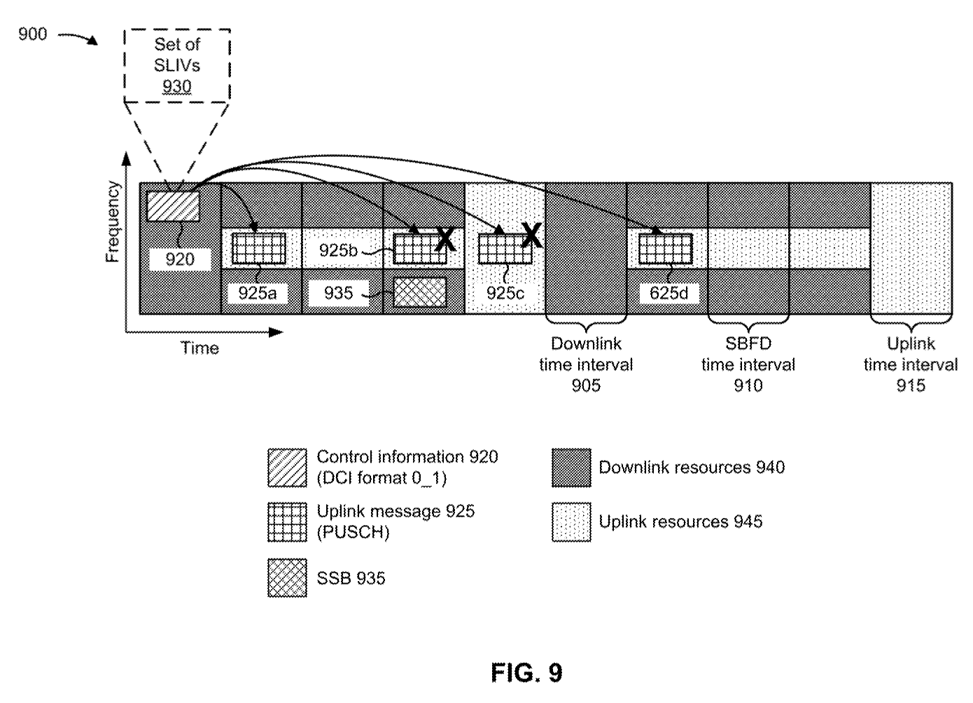

FIG. 9 is a diagram illustrating example 900 associated with an uplink message validation for multiple uplink messages scheduled by DCI format 0_1 during full-duplex operations. In some instances, example 900 may implement or be implemented by one or more aspects of FIGS. 1 through 6. For instance, FIG. 9 may illustrate a wireless communications timeline between the network node 110 and the UE 120. In some examples, downlink time intervals 905, SBFD time intervals 910, and uplink time intervals 915 may be respective examples of the downlink time intervals 605, the SBFD time intervals 610, and the uplink time intervals 615. In other words, example 900 may be associated with a same SBFD configuration as example 600. In some examples, a set of uplink messages 925 (e.g., uplink message 925a, 925b, 925c, and 925d) may be an example of the set of uplink messages 625. In some examples, an SSB 935 may be an example of the SSB 635. In some examples, downlink resources 940 and uplink resources 945 may be respective examples of downlink resources 525 and uplink resources 530. Additionally, the techniques described with reference to example 900 may be for scenarios where the UE 120 is operating in accordance with the first configuration 505 and the valid symbol-type is SBFD symbols (e.g., based on a first transmission occasion including SBFD symbols).

As shown in FIG. 9, the network node 110 may transmit, and the UE 120 may receive, the control information 920 that schedules a set of uplink messages 925. In some examples, the control information 920 may be a DCI of format 0_1. As shown in FIG. 9, the control information 920 may indicate multiple start and length indicator values (SLIVs) (e.g., a set of SLIVs 930), where the set of SLIVs 930 may respectively indicate a set of time resources for the set of uplink messages 925. In some examples, the set of SLIVs 930 indicated by the control information 920 may be associated with RRC signaling received by the UE 120 from the network node 110 prior to transmission of the control information 920. For example, the RRC signaling may indicate a parameter (e.g., pusch-TimeDomainAllocationListForMultiPUSCH) that includes a list of time-domain resource allocations for PUSCH transmissions. Additionally, each entry in the list may specify the start and length of a given PUSCH transmission using SLIVs. To enable scheduling of multiple PUSCHs using DCI format 0_1, the list may include multiple rows, where each row may include multiple SLIVs. Accordingly, the multiple rows of the list may enable the network node 110 to schedule the UE 120 with multiple PUSCH transmissions in different time intervals.

In accordance with being configured with the parameter pusch-TimeDomainAllocationListForMultiPUSCH, the control information 920 (DCI format 0_1) may indicate the set of SLIVs 930 by referencing the list of time-domain resource allocations configured by the parameter. Therefore, with reference to example 900, the control information 920 may indicate a first SLIV that indicates a time allocation of the uplink message 925a, a second SLIV that indicates a time allocation of the uplink message 925b, a third SLIV that indicates a time allocation of the uplink message 925c, and a fourth SLIV that indicates a time allocation of the uplink message 925d. Accordingly, the control information 920 may include detailed time-domain allocations for PUSCH transmissions, allowing the UE 120 to handle multiple PUSCHs efficiently within the uplink bandwidth part of a serving cell.

In accordance with the techniques of example 900, if the UE 120 is configured with the first configuration 505 for uplink transmissions per uplink bandwidth part, and UE 120 is scheduled with multiple uplink messages 925 by the control information 920 (e.g., one or more rows include multiple SLIVs for PUSCH on an uplink bandwidth part of a serving cell), and an initial or first transmission occasion for the uplink messages 925 is associated with SBFD symbols, then the UE 120 may not expect to be scheduled with one or multiple PUSCH transmissions that overlap with non-SBFD symbols (e.g., downlink, uplink, or flexible symbols) or a symbol of an SSB transmission (e.g., SS/PBCH block with index provided by ssb-PositionsInBurst). For instance, as shown in FIG. 9, the uplink messages 925a and 925d are respectively scheduled during SBFD symbols and do not overlap with SSB symbols or non-SBFD symbols. Accordingly, the UE 120 may identify or determine that the uplink messages 925a and 925d are valid, and may transmit the uplink messages 925a and 925d to the network node 110.

Additionally, in accordance with the techniques of example 900, the UE 120 may not expect for the network node 110 to schedule (via the control information 920) uplink messages 925 during SSB symbols or non-SBFD symbols. For instance, as shown in FIG. 9, the uplink message 925b is scheduled during one or more SBFD symbols; however, the one or more SBFD symbols at least partially overlap in time with one or more symbols scheduled for the SSB 935. Therefore, the UE 120 may drop the uplink message 925b (e.g., refrain from transmitting the uplink message 925b). Additionally, as shown in FIG. 9, the uplink message 925c is scheduled during an uplink time interval 915 that includes one or more non-SBFD symbols (e.g., symbols scheduled only for uplink). Therefore, the UE 120 may drop the uplink message 925c (e.g., refrain from transmitting the uplink message 925c).

Accordingly, the techniques of example 900 may enable the UE 120 to validate which of the scheduled set of uplink messages 925 (scheduled via DCI format 0_1) are valid for transmission if the UE 120 is configured with the first configuration 505 and the valid symbol-type is SBFD symbols. Therefore, the techniques of example 900 may enable the UE 120 to perform uplink message validation during time intervals associated with SBFD operations.

As indicated above, FIG. 9 is provided as an example. Other examples may differ from what is described with respect to FIG. 9.

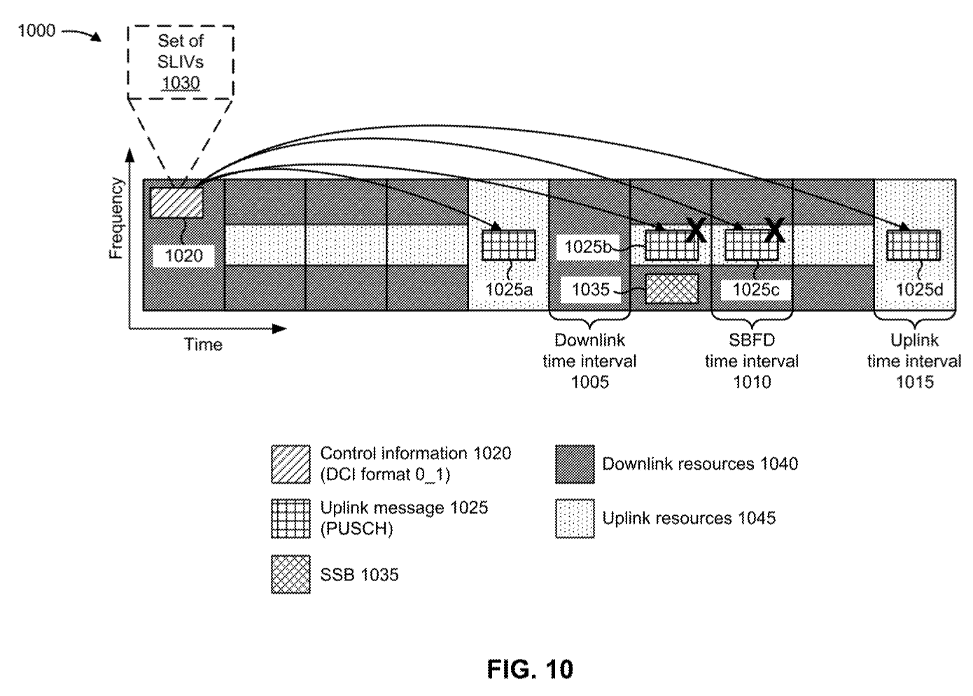

FIG. 10 is a diagram illustrating example 1000 associated with an uplink message validation for multiple uplink messages scheduled by DCI format 0_1 during full-duplex operations. In some instances, example 1000 may implement or be implemented by one or more aspects of FIGS. 1 through 6 and 9. For instance, FIG. 10 may illustrate a wireless communications timeline between the network node 110 and the UE 120. In some examples, downlink time intervals 1005, SBFD time intervals 1010, and uplink time intervals 1015 may be respective examples of the downlink time intervals 605, the SBFD time intervals 610, and the uplink time intervals 615. In other words, example 1000 may be associated with a same SBFD configuration as example 600. In some examples, the control information 1020 may be an example of the control information 920 (e.g., DCI format 0_1). In some examples, the set of SLIVs 1030 may be an example of the set of SLIVs 930. In some examples, a set of uplink messages 1025 (e.g., uplink message 1025a, 1025b, 1025c, and 1025d) may be an example of the set of uplink messages 625. In some examples, an SSB 1035 may be an example of the SSB 635. In some examples, downlink resources 1040 and uplink resources 1045 may be respective examples of downlink resources 525 and uplink resources 530. Additionally, the techniques described with reference to example 1000 may be for scenarios where the UE 120 is operating in accordance with the first configuration 505 and the valid symbol-type is non-SBFD symbols (e.g., based on a first transmission occasion including non-SBFD symbols).

As shown in FIG. 10, the network node 110 may transmit, and the UE 120 may receive, the control information 1020 that schedules a set of uplink messages 1025. In some examples, the control information 1020 may be a DCI of format 0_1, as described elsewhere herein. As shown in FIG. 10, the control information 1020 may indicate a set of SLIVs 1030, where the set of SLIVs 1030 may respectively indicate a set of time resources for the set of uplink messages 1025, as described elsewhere herein.

In accordance with the techniques of example 1000, if the UE 120 is configured with the first configuration 505 for uplink transmissions per uplink bandwidth part, and UE 120 is scheduled with multiple uplink messages 1025 by the control information 1020 (e.g., one or more rows include multiple SLIVs for PUSCH on an uplink bandwidth part of a serving cell), and an initial or first transmission occasion for the uplink messages 1025 is associated with non-SBFD symbols, then the UE 120 may not expect to be scheduled with one or multiple PUSCH transmissions that overlap with SBFD symbols, downlink symbols, or a symbol of an SSB transmission (e.g., SS/PBCH block with index provided by ssb-PositionsInBurst). For instance, as shown in FIG. 10, the uplink messages 1025a and 1025d are respectively scheduled during uplink symbols or flexible symbols and do not overlap with SSB symbols, downlink symbols, or SBFD symbols. Accordingly, the UE 120 may identify or determine that the uplink messages 1025a and 1025d are valid, and may transmit the uplink messages 1025a and 1025d to the network node 110.

Additionally, in accordance with the techniques of example 1000, the UE 120 may not expect for the network node 110 to schedule (via the control information 1020) uplink messages 1025 during SSB symbols, downlink symbols, or SBFD symbols. For instance, as shown in FIG. 10, the uplink message 1025b is scheduled during one or more SBFD symbols that at least partially overlap in time with one or more symbols scheduled for the SSB 1035. Therefore, the UE 120 may drop the uplink message 1025b (e.g., refrain from transmitting the uplink message 1025b). Additionally, as shown in FIG. 10, the uplink message 1025c is scheduled during an SBFD time interval 1010 that includes one or more SBFD symbols. Therefore, the UE 120 may drop the uplink message 1025c (e.g., refrain from transmitting the uplink message 1025c).

Accordingly, the techniques of example 1000 may enable the UE 120 to validate which of the scheduled set of uplink messages 1025 (scheduled via DCI format 0_1) are valid for transmission if the UE 120 is configured with the first configuration 505 and the valid symbol-type is non-SBFD symbols. Therefore, the techniques of example 1000 may enable the UE 120 to perform uplink message validation during time intervals associated with SBFD operations.

As indicated above, FIG. 10 is provided as an example. Other examples may differ from what is described with respect to FIG. 10.

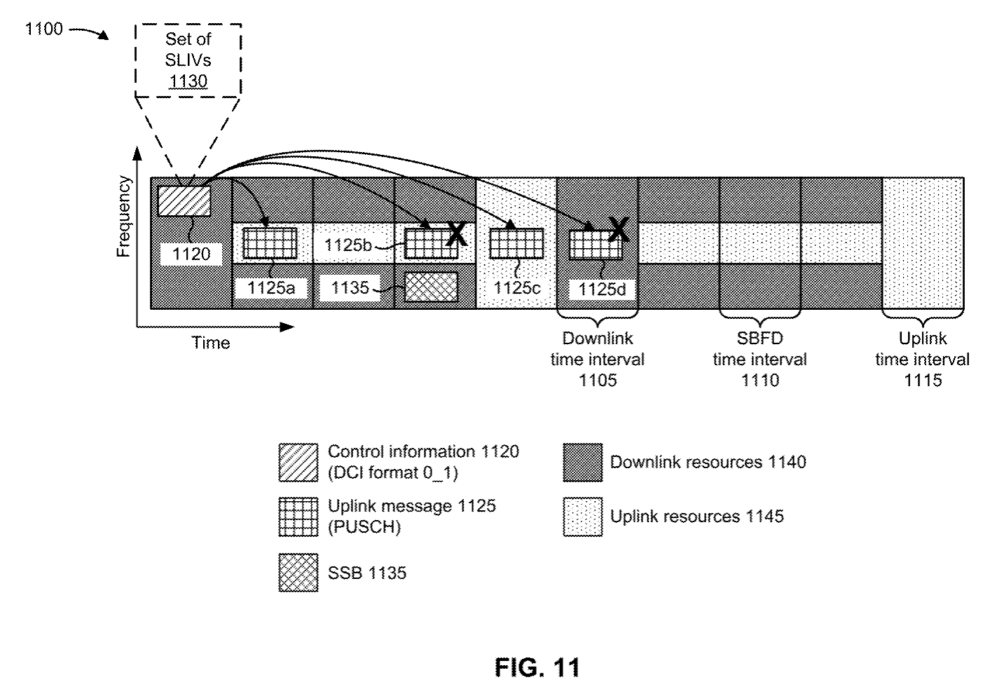

FIG. 11 is a diagram illustrating example 1100 associated with an uplink message validation for multiple uplink messages scheduled by DCI format 0_1 during full-duplex operations. In some instances, example 1100 may implement or be implemented by one or more aspects of FIGS. 1 through 6 and 9. For instance, FIG. 11 may illustrate a wireless communications timeline between the network node 110 and the UE 120. In some examples, downlink time intervals 1105, SBFD time intervals 1110, and uplink time intervals 1115 may be respective examples of the downlink time intervals 605, the SBFD time intervals 610, and the uplink time intervals 615. In other words, example 1100 may be associated with a same SBFD configuration as example 600. In some examples, the control information 1120 may be an example of the control information 920 (e.g., DCI format 0_1). In some examples, the set of SLIVs 1130 may be an example of the set of SLIVs 930. In some examples, a set of uplink messages 1125 (e.g., uplink message 1125a, 1125b, 1125c, and 1125d) may be an example of the set of uplink messages 625. In some examples, an SSB 1135 may be an example of the SSB 635. In some examples, downlink resources 1140 and uplink resources 1145 may be respective examples of downlink resources 525 and uplink resources 530. Additionally, the techniques described with reference to example 1100 may be for scenarios where the UE 120 is operating in accordance with the second configuration 510 (e.g., the UE 120 is enabled to transmit the uplink messages 825 during both non-SBFD symbols and SBFD symbols).

As shown in FIG. 11, the network node 110 may transmit, and the UE 120 may receive, the control information 1120 that schedules the set of uplink messages 1125. In some examples, the control information 1120 may be a DCI of format 0_1, as described elsewhere herein. As shown in FIG. 11, the control information 1120 may indicate a set of SLIVs 1130, where the set of SLIVs 1130 may respectively indicate a set of time resources for the set of uplink messages 1125, as described elsewhere herein.

In accordance with the techniques of example 1100, if the UE 120 is configured with the second configuration 510 for uplink transmissions per uplink bandwidth part, and UE 120 is scheduled with multiple uplink messages 1125 by the control information 1120 (e.g., one or more rows include multiple SLIVs for PUSCH on an uplink bandwidth part of a serving cell), then the UE 120 may not expect to be scheduled with one or multiple PUSCH transmissions that overlap with downlink symbols (not configured as SBFD) or a symbol of an SSB transmission (e.g., SS/PBCH block with index provided by ssb-PositionsInBurst). For instance, as shown in FIG. 11, the uplink messages 1125a and 1125c are respectively scheduled during uplink symbols, flexible symbols, or SBFD symbols and do not overlap with SSB symbols or downlink symbols. Accordingly, the UE 120 may identify or determine that the uplink messages 1125a and 1125c are valid, and may transmit the uplink messages 1125a and 1125c to the network node 110.

Additionally, in accordance with the techniques of example 1100, the UE 120 may not expect for the network node 110 to schedule (via the control information 1120) uplink messages 1125 during SSB symbols or downlink symbols (not scheduled for SBFD). For instance, as shown in FIG. 11, the uplink message 1125b is scheduled during one or more SBFD symbols; however, the one or more SBFD symbols at least partially overlap in time with one or more symbols scheduled for the SSB 1135. Therefore, the UE 120 may drop the uplink message 1125b (e.g., refrain from transmitting the uplink message 1125b). Additionally, as shown in FIG. 11, the uplink message 1125d is scheduled during a downlink time interval 1105 that includes one or more downlink symbols not configured for SBFD. Therefore, the UE 120 may drop the uplink message 1125d (e.g., refrain from transmitting the uplink message 1125d).

Accordingly, the techniques of example 1100 may enable the UE 120 to validate which of the scheduled set of uplink messages 1125 (scheduled via DCI format 0_1) are valid for transmission if the UE 120 is configured with the second configuration 510. Therefore, the techniques of example 1100 may enable the UE 120 to perform uplink message validation during time intervals associated with SBFD operations.

As indicated above, FIG. 11 is provided as an example. Other examples may differ from what is described with respect to FIG. 11.

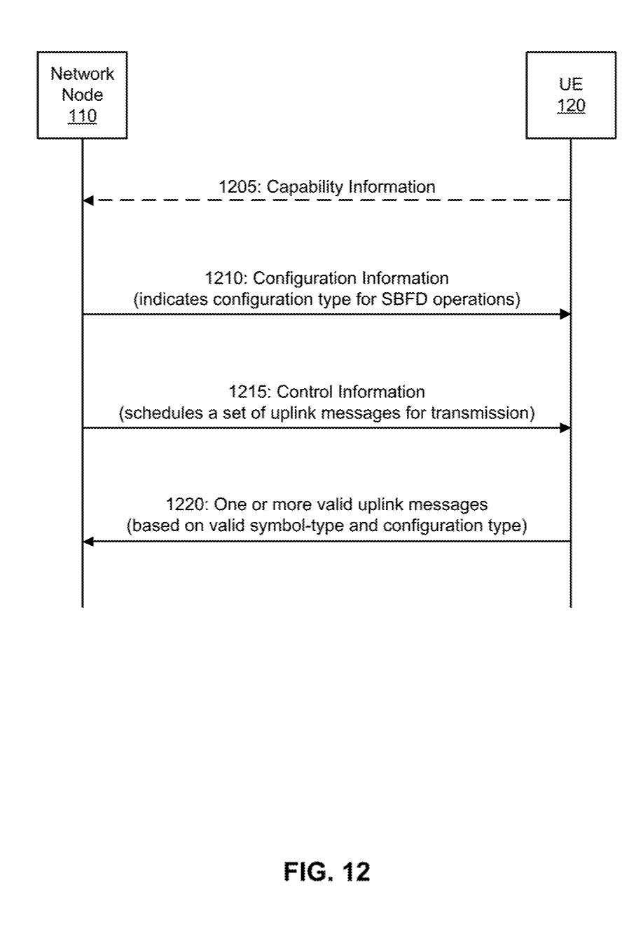

FIG. 12 is a diagram illustrating an example 1200 associated with signaling that enables multi-uplink transmission validation during full-duplex operations. Example 1200 may implement or be implemented by one or more aspects of FIGS. 1 through 11. For instance, example 1200 includes wireless communications between the network node 110 and the UE 120. Alternative examples of the following operations of example 1200 may be implemented, where some operations are performed in a different order than described, or not described at all. In some cases, one or more operations may include additional features not mentioned below, or further operations may be added. In addition, while example 1200 shows operations between the UE 120 and the network node 110, the communications may occur between any number of network devices of various types described herein.

In a first operation 1205, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter that the UE 120 is an SBFD-aware UE 120. In other words, the capability information may indicate that the UE 120 is capable of operating in accordance with an SBFD configuration that configures one or more SBFD time intervals and one or more non-SBFD time intervals. In some examples, the capability information may indicate whether the UE 120 supports the second configuration 510. For instance, the first configuration 505 may be a default configuration type for SBFD operations, and as part of the capability information, the UE 120 may indicate whether the UE 120 additionally supports the second configuration 510. One or more operations described herein may be based on the capability information. For example, the UE 120 may perform one or more operations of example 1200 in accordance with the capability information or may receive one or more of configuration information or control information that is in accordance with the capability information.

The network node 110 may determine configuration information for the UE 120 based on the capability information. For example, the network node 110 may determine that the UE 120 is capable of operating in accordance with an SBFD configuration based on the capability information indicating that the UE 120 is SBFD-aware.

In a second operation 1210, the network node 110 may transmit, and the UE 120 may receive, the configuration information. In some aspects, the UE 120 may receive the configuration information via one or more of system information signaling (e.g., a master information block (MIB) or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may include an SBFD configuration (e.g., the SBFD configuration 408). For example, the SBFD configuration may configure one or more SBFD time intervals (e.g., SBFD time intervals 610) and one or more non-SBFD time intervals (e.g., one or more of downlink time intervals 605, uplink intervals 615, or flexible time intervals described elsewhere herein).

In some examples, the configuration information may indicate one of a first configuration type or a second configuration type associated with SBFD operation. For example, the first configuration type may enable uplink transmissions during one of the one or more SBFD time intervals or the one or more non-SBFD time intervals (e.g., the first configuration 505). Additionally, the second configuration type may enable uplink transmissions during both of the one or more SBFD time intervals and the one or more non-SBFD time intervals (e.g., the second configuration 510).

In some examples, the configuration information may indicate a parameter associated with one or more SSB transmissions (e.g., ssb-PositionsInBurst). For example, the ssb-PositionsInBurst parameter may indicate the positions of one or more SSBs within a burst. An SSB burst may be a group of SSBs transmitted periodically, and each SSB may include a primary synchronization signal (PSS), a secondary synchronization signal (SSS), and a physical broadcast channel (PBCH). In some examples, the ssb-PositionsInBurst parameter may indicate the positions of one or more SSBs via an index. For example, if the ssb-PositionsInBurst parameter is set to “10101000,” then SSBs may be present at positions 0, 2, and 4 within the burst, and no SSBs are present at positions 1, 3, 5, 6, and 7. In some other examples, an SSB transmission may be referred to herein as an “SS/PBCH block.”

In some examples, the configuration information may indicate a parameter associated with scheduling multiple PUSCH transmissions using a single DCI (e.g., pusch-TimeDomainAllocationListForMultiPUSCH). For example, the pusch-TimeDomainAllocationListForMultiPUSCH parameter may indicate a time-domain resource allocation configuration that can be used for scheduling multiple PUSCH transmissions. In some examples, each entry in this list defines a specific time-domain allocation pattern that can be applied to a PUSCH transmission. The pusch- TimeDomainAllocationListForMultiPUSCH parameter may be used in conjunction with DCI formats that support the scheduling of multiple PUSCH transmissions. For example, DCI format 0_1 can schedule multiple PUSCH transmissions using a set of SLIVs (e.g., the set of SLIVs 930, 1030, and 1130).

In a third operation 1215, the network node 110 may transmit, and the UE 120, may receive, control information that schedules a set of uplink messages. For example, the control information may be an example of the control information 620, 720, or 820 (e.g., single DCI scheduling multiple PUSCH transmissions respectively associated with multiple HARQ processes) or an example of the control information 920, 1020, or 1120 (e.g., DCI format 0_1 scheduling multiple PUSCH transmissions via a set of SLIVs). Additionally, the set uplink messages may be an example of the set of uplink messages 625, 725, 825, 925, 1025, or 1125.

In a fourth operation 1220, the UE 120 may transmit, and the network node 110 may receive, one or more valid uplink messages from the set of uplink messages (scheduled in the third operation 1215). For example, the UE 120 may transmit a first uplink message from the set of uplink messages in accordance with the first uplink message being valid, where the first uplink message may be valid in accordance with being scheduled during a valid symbol-type and based on the configuration type (e.g., the first configuration 505 or the second configuration 510).

In some examples, the control information indicates a first HARQ process identifier, the configuration type enables uplink transmissions during one of the one or more SBFD time intervals or the one or more non-SBFD time intervals (e.g., the first configuration 505), and the valid symbol-type is SBFD symbols. Accordingly, the first uplink message may be valid and associated with the first HARQ process identifier based on being an earliest uplink message scheduled in time of the set of uplink messages that is scheduled during exclusively one or more first SBFD symbols that do not overlap in time with an SSB. In such examples, a second uplink message of the set of uplink messages may be valid and associated with a second HARQ process identifier based on being a next earliest uplink message after the first uplink message that is scheduled during exclusively one or more second SBFD symbols that do not overlap in time with an SSB. Additionally, the second HARQ process identifier may be incremented by one relative to the first HARQ process identifier.

In some examples, the control information indicates a first HARQ process identifier, the configuration type enables uplink transmissions during one of the one or more SBFD time intervals or the one or more non-SBFD time intervals (e.g., the first configuration 505), and the valid symbol-type is non-SBFD symbols. Accordingly, the first uplink message may be valid and associated with the first HARQ process identifier based on being an earliest uplink message scheduled in time of the set of uplink messages that is scheduled during exclusively one or more first uplink or flexible symbols that do not overlap with downlink or SBFD symbols and do not overlap in time with an SSB. In such examples, a second uplink message of the set of uplink messages may be valid and associated with a second HARQ process identifier based on being a next earliest uplink message after the first uplink message that is scheduled during exclusively one or more second uplink or flexible symbols that do not overlap with downlink or SBFD symbols and do not overlap in time with an SSB, and the second HARQ process identifier is incremented by one relative to the first HARQ process identifier.

In some examples, the control information indicates a first HARQ process identifier and the configuration type enables uplink transmissions during both the one or more SBFD time intervals and the one or more non-SBFD time intervals (e.g., the second configuration 510). Accordingly, the first uplink message may be valid and associated with the first HARQ process identifier based on being an earliest uplink message scheduled in time of the set of uplink messages that is scheduled during exclusively one or more first uplink, flexible, or SBFD symbols that do not overlap in time with an SSB. In such examples, a second uplink message of the set of uplink messages is valid and associated with a second HARQ process identifier based on being a next earliest uplink message after the first uplink message that is scheduled during exclusively one or more second uplink, flexible, or SBFD symbols that do not overlap in time with an SSB, and the second HARQ process identifier is incremented by one relative to the first HARQ process identifier.

In some examples, the control information may include a DCI format 0_1 and indicates a set of SLIVs respectively associated with the set of uplink messages, the configuration type enables uplink transmissions during one of the one or more SBFD time intervals or the one or more non-SBFD time intervals (e.g., the first configuration 505), and the valid symbol-type is non-SBFD symbols. Accordingly, the first uplink message is valid based on being associated with an SLIV that schedules the first uplink message during exclusively one or more SBFD symbols that do not overlap in time with an SSB.

In some examples, the control information may include a DCI format 0_1 and indicates a set of SLIVs respectively associated with the set of uplink messages, the configuration type enables uplink transmissions during one of the one or more SBFD time intervals or the one or more non-SBFD time intervals (e.g., the first configuration 505), and the valid symbol-type is non-SBFD symbols. Accordingly, the first uplink message is valid based on being associated with an SLIV that schedules the first uplink message during exclusively one or more uplink or flexible symbols that do not overlap with downlink or SBFD symbols and do not overlap in time with an SSB.

In some examples, the control information may include a DCI format 0_1 and indicates a set of SLIVs respectively associated with the set of uplink messages and the configuration type enables uplink transmissions during both of the one or more SBFD time intervals or the one or more non-SBFD time intervals (e.g., the second configuration 510). Accordingly, the first uplink message is valid based on being associated with an SLIV that schedules the first uplink message during exclusively one or more uplink, flexible, or SBFD symbols that do not overlap in time with an SSB.

Therefore, the network node 110 may receive the one or more uplink messages from the UE 120 based on the UE 120 validating the one or more uplink messages in accordance with one or more of the techniques described herein.

As indicated above, FIG. 12 is provided as an example. Other examples may differ from what is described with respect to FIG. 12.

FIG. 13 is a diagram illustrating an example process 1300 performed, for example, at a UE or an apparatus of a UE. Example process 1300 is an example where the apparatus or the UE (e.g., the UE 120) performs operations associated with multi-uplink transmission validation during full-duplex operations.

As shown in FIG. 13, in some aspects, process 1300 may include receiving, from a network node, configuration information that indicates a configuration type for wireless communications during one or more SBFD time intervals and one or more non-SBFD time intervals (block 1310). For example, the UE (e.g., using reception component 1502 or communication manager 1506, depicted in FIG. 15) may receive, from a network node, configuration information that indicates a configuration type for wireless communications during one or more SBFD time intervals and one or more non-SBFD time intervals, as described above.

As further shown in FIG. 13, in some aspects, process 1300 may include receiving, from the network node, control information that schedules a set of uplink messages (block 1320). For example, the UE (e.g., using reception component 1502 or communication manager 1506, depicted in FIG. 15) may receive, from the network node, control information that schedules a set of uplink messages, as described above.

As further shown in FIG. 13, in some aspects, process 1300 may include transmitting, to the network node, a first uplink message from the set of uplink messages in accordance with the first uplink message being valid, where the first uplink message is valid in accordance with being scheduled during a valid symbol-type and based at least in part on the configuration type (block 1330). For example, the UE (e.g., using transmission component 1504 or communication manager 1506, depicted in FIG. 15) may transmit, to the network node, a first uplink message from the set of uplink messages in accordance with the first uplink message being valid, where the first uplink message is valid in accordance with being scheduled during a valid symbol-type and based at least in part on the configuration type, as described above.

Process 1300 may include additional aspects, such as any single aspect or any combination of aspects described below or in connection with one or more other processes described elsewhere herein.

In a first aspect, the control information indicates a first HARQ process identifier, the configuration type enables uplink transmissions during one of the one or more SBFD time intervals or the one or more non-SBFD time intervals, the valid symbol-type is SBFD symbols, and the first uplink message is valid and is associated with the first HARQ process identifier based at least in part on being an earliest uplink message scheduled in time of the set of uplink messages that is scheduled during exclusively one or more first SBFD symbols that do not overlap in time with an SSB.

In a second aspect, alone or in combination with the first aspect, a second uplink message of the set of uplink messages is valid and associated with a second HARQ process identifier based at least in part on being a next earliest uplink message after the first uplink message that is scheduled during exclusively one or more second SBFD symbols that do not overlap in time with an SSB, and the second HARQ process identifier is incremented by one relative to the first HARQ process identifier.

In a third aspect, alone or in combination with one or more of the first and second aspects, the control information indicates a first HARQ process identifier, the configuration type enables uplink transmissions during one of the one or more SBFD time intervals or the one or more non-SBFD time intervals, the valid symbol-type is non-SBFD symbols, and the first uplink message is valid and is associated with the first HARQ process identifier based at least in part on being an earliest uplink message scheduled in time of the set of uplink messages that is scheduled during exclusively one or more first uplink or flexible symbols that do not overlap with downlink or SBFD symbols and do not overlap in time with an SSB.

In a fourth aspect, alone or in combination with one or more of the first through third aspects, a second uplink message of the set of uplink messages is valid and associated with a second HARQ process identifier based at least in part on being a next earliest uplink message after the first uplink message that is scheduled during exclusively one or more second uplink or flexible symbols that do not overlap with downlink or SBFD symbols and do not overlap in time with an SSB, and the second HARQ process identifier is incremented by one relative to the first HARQ process identifier.

In a fifth aspect, alone or in combination with one or more of the first through fourth aspects, the control information indicates a first HARQ process identifier, the configuration type enables uplink transmissions during both the one or more SBFD time intervals and the one or more non-SBFD time intervals, and the first uplink message is valid and is associated with the first HARQ process identifier based at least in part on being an earliest uplink message scheduled in time of the set of uplink messages that is scheduled during exclusively one or more first uplink, flexible, or SBFD symbols that do not overlap in time with an SSB.

In a sixth aspect, alone or in combination with one or more of the first through fifth aspects, a second uplink message of the set of uplink messages is valid and associated with a second HARQ process identifier based at least in part on being a next earliest uplink message after the first uplink message that is scheduled during exclusively one or more second uplink, flexible, or SBFD symbols that do not overlap in time with an SSB, and the second HARQ process identifier is incremented by one relative to the first HARQ process identifier.

In a seventh aspect, alone or in combination with one or more of the first through sixth aspects, the control information comprises a DCI format 0_1 and indicates a set of SLIVs respectively associated with the set of uplink messages, and the configuration type enables uplink transmissions during one of the one or more SBFD time intervals or the one or more non-SBFD time intervals.

In an eighth aspect, alone or in combination with one or more of the first through seventh aspects, the valid symbol-type is SBFD symbols, and the first uplink message is valid based at least in part on being associated with an SLIV that schedules the first uplink message during exclusively one or more SBFD symbols that do not overlap in time with an SSB.

In a ninth aspect, alone or in combination with one or more of the first through eighth aspects, the valid symbol-type is non-SBFD symbols, and the first uplink message is valid based at least in part on being associated with an SLIV that schedules the first uplink message during exclusively one or more uplink or flexible symbols that do not overlap with downlink or SBFD symbols and do not overlap in time with an SSB.

In a tenth aspect, alone or in combination with one or more of the first through ninth aspects, the control information comprises a DCI format 0_1 and indicates a set of SLIVs respectively associated with the set of uplink messages, the configuration type enables uplink transmissions during both of the one or more SBFD time intervals or the one or more non-SBFD time intervals, and the first uplink message is valid based at least in part on being associated with an SLIV that schedules the first uplink message during exclusively one or more uplink, flexible, or SBFD symbols that do not overlap in time with an SSB.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node. Example process 1400 is an example where the apparatus or the network node (e.g., network node 110) performs operations associated with multi-uplink transmission validation during full-duplex operations.

As shown in FIG. 14, in some aspects, process 1400 may include transmitting, to a UE, configuration information that indicates a configuration type for wireless communications during one or more SBFD time intervals and one or more non-SBFD time intervals (block 1410). For example, the network node (e.g., using transmission component 1604 or communication manager 1606, depicted in FIG. 16) may transmit, to a UE, configuration information that indicates a configuration type for wireless communications during one or more SBFD time intervals and one or more non-SBFD time intervals, as described above.

As further shown in FIG. 14, in some aspects, process 1400 may include transmitting, to the UE, control information that schedules a set of uplink messages (block 1420). For example, the network node (e.g., using transmission component 1604 or communication manager 1606, depicted in FIG. 16) may transmit, to the UE, control information that schedules a set of uplink messages, as described above.

As further shown in FIG. 14, in some aspects, process 1400 may include receiving, from the UE, a first uplink message from the set of uplink messages in accordance with the first uplink message being valid, where the first uplink message is valid in accordance with being scheduled during a valid symbol-type and based at least in part on the configuration type (block 1430). For example, the network node (e.g., using reception component 1602 or communication manager 1606, depicted in FIG. 16) may receive, from the UE, a first uplink message from the set of uplink messages in accordance with the first uplink message being valid, where the first uplink message is valid in accordance with being scheduled during a valid symbol-type and based at least in part on the configuration type, as described above.

Process 1400 may include additional aspects, such as any single aspect or any combination of aspects described below or in connection with one or more other processes described elsewhere herein.

In a first aspect, the control information indicates a first HARQ process identifier, the configuration type enables uplink transmissions during one of the one or more SBFD time intervals or the one or more non-SBFD time intervals, the valid symbol-type is SBFD symbols, and the first uplink message is valid and is associated with the first HARQ process identifier based at least in part on being an earliest uplink message scheduled in time of the set of uplink messages that is scheduled during exclusively one or more first SBFD symbols that do not overlap in time with an SSB.

In a second aspect, alone or in combination with the first aspect, a second uplink message of the set of uplink messages is valid and associated with a second HARQ process identifier based at least in part on being a next earliest uplink message after the first uplink message that is scheduled during exclusively one or more second SBFD symbols that do not overlap in time with an SSB, and the second HARQ process identifier is incremented by one relative to the first HARQ process identifier.

In a third aspect, alone or in combination with one or more of the first and second aspects, the control information indicates a first HARQ process identifier, the configuration type enables uplink transmissions during one of the one or more SBFD time intervals or the one or more non-SBFD time intervals, the valid symbol-type is non-SBFD symbols, and the first uplink message is valid and is associated with the first HARQ process identifier based at least in part on being an earliest uplink message scheduled in time of the set of uplink messages that is scheduled during exclusively one or more first uplink or flexible symbols that do not overlap with downlink or SBFD symbols and do not overlap in time with an SSB.

In a fourth aspect, alone or in combination with one or more of the first through third aspects, a second uplink message of the set of uplink messages is valid and associated with a second HARQ process identifier based at least in part on being a next earliest uplink message after the first uplink message that is scheduled during exclusively one or more second uplink or flexible symbols that do not overlap with downlink or SBFD symbols and do not overlap in time with an SSB, and the second HARQ process identifier is incremented by one relative to the first HARQ process identifier.

In a fifth aspect, alone or in combination with one or more of the first through fourth aspects, the control information indicates a first HARQ process identifier, the configuration type enables uplink transmissions during both the one or more SBFD time intervals and the one or more non-SBFD time intervals, and the first uplink message is valid and is associated with the first HARQ process identifier based at least in part on being an earliest uplink message scheduled in time of the set of uplink messages that is scheduled during exclusively one or more first uplink, flexible, or SBFD symbols that do not overlap in time with an SSB.

In a sixth aspect, alone or in combination with one or more of the first through fifth aspects, a second uplink message of the set of uplink messages is valid and associated with a second HARQ process identifier based at least in part on being a next earliest uplink message after the first uplink message that is scheduled during exclusively one or more second uplink, flexible, or SBFD symbols that do not overlap in time with an SSB, and the second HARQ process identifier is incremented by one relative to the first HARQ process identifier.

In a seventh aspect, alone or in combination with one or more of the first through sixth aspects, the control information comprises a DCI format 0_1 and indicates a set of SLIVs respectively associated with the set of uplink messages, and the configuration type enables uplink transmissions during one of the one or more SBFD time intervals or the one or more non-SBFD time intervals.

In an eighth aspect, alone or in combination with one or more of the first through seventh aspects, the valid symbol-type is SBFD symbols, and the first uplink message is valid based at least in part on being associated with an SLIV that schedules the first uplink message during exclusively one or more SBFD symbols that do not overlap in time with an SSB.

In a ninth aspect, alone or in combination with one or more of the first through eighth aspects, the valid symbol-type is non-SBFD symbols, and the first uplink message is valid based at least in part on being associated with an SLIV that schedules the first uplink message during exclusively one or more uplink or flexible symbols that do not overlap with downlink or SBFD symbols and do not overlap in time with an SSB.

In a tenth aspect, alone or in combination with one or more of the first through ninth aspects, the control information comprises a DCI format 0_1 and indicates a set of SLIVs respectively associated with the set of uplink messages, the configuration type enables uplink transmissions during both of the one or more SBFD time intervals or the one or more non-SBFD time intervals, and the first uplink message is valid based at least in part on being associated with an SLIV that schedules the first uplink message during exclusively one or more uplink, flexible, or SBFD symbols that do not overlap in time with an SSB.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE, or a UE may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 140 described in connection with FIG. 1) of the UE.

In some aspects, the apparatus 1500 may be configured to perform one or more operations described herein in connection with FIGS. 3 through 12. Additionally, or alternatively, the apparatus 1500 may be configured to perform one or more processes described herein, such as process 1300 of FIG. 13. In some aspects, the apparatus 1500 or one or more components shown in FIG. 15 may include one or more components of the UE described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the UE described above in connection with FIG. 1, such as a radio, one or more RF chains, one or more transceivers, or one or more modems, each of which may in turn be coupled with one or more antennas of the UE.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

The reception component 1502 may receive, from a network node, configuration information that indicates a configuration type for wireless communications during one or more SBFD time intervals and one or more non-SBFD time intervals. The reception component 1502 may receive, from the network node, control information that schedules a set of uplink messages. The transmission component 1504 may transmit, to the network node, a first uplink message from the set of uplink messages in accordance with the first uplink message being valid, wherein the first uplink message is valid in accordance with being scheduled during a valid symbol-type and based at least in part on the configuration type.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a network node, or a network node may include the apparatus 1600. In some aspects, the apparatus 1600 includes a reception component 1602, a transmission component 1604, or a communication manager 1606, which may be in communication with one another (for example, via one or more buses or one or more other components). In some aspects, the communication manager 1606 is the communication manager 155 described in connection with FIG. 1. As shown, the apparatus 1600 may communicate with another apparatus 1608, such as a UE or a network node (such as a CU, a DU, an RU, or a base station), using the reception component 1602 and the transmission component 1604. The communication manager 1606 may be included in, or implemented via, a processing system (for example, the processing system 145 described in connection with FIG. 1) of the network node.

In some aspects, the apparatus 1600 may be configured to perform one or more operations described herein in connection with FIGS. 3 through 12. Additionally, or alternatively, the apparatus 1600 may be configured to perform one or more processes described herein, such as process 1400 of FIG. 14. In some aspects, the apparatus 1600 or one or more components shown in FIG. 16 may include one or more components of the network node described in connection with FIG. 1. Additionally, or alternatively, one or more components shown in FIG. 16 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications, and may provide the processed signals to the one or more other components of the apparatus 1600. In some aspects, the reception component 1602 may include one or more components of the network node described above in connection with FIG. 1, such as a radio, one or more RF chains, one or more transceivers, or one or more modems, each of which may in turn be coupled with one or more antennas of the network node. In some aspects, the reception component 1602 or the transmission component 1604 may include or may be included in a network interface. The network interface may be configured to obtain or output signals for the apparatus 1600 via one or more communications links, such as a backhaul link, a midhaul link, or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications, and may transmit the processed signals to the apparatus 1608. In some aspects, the transmission component 1604 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1604 may be co-located with the reception component 1602.

The communication manager 1606 may support operations of the reception component 1602 or the transmission component 1604. For example, the communication manager 1606 may receive information associated with configuring reception of communications by the reception component 1602 or transmission of communications by the transmission component 1604. Additionally, or alternatively, the communication manager 1606 may generate or provide control information to the reception component 1602 or the transmission component 1604 to control reception or transmission of communications.

The transmission component 1604 may transmit, to a UE, configuration information that indicates a configuration type for wireless communications during one or more SBFD time intervals and one or more non-SBFD time intervals. The transmission component 1604 may transmit, to the UE, control information that schedules a set of uplink messages. The reception component 1602 may receive, from the UE, a first uplink message from the set of uplink messages in accordance with the first uplink message being valid, wherein the first uplink message is valid in accordance with being scheduled during a valid symbol-type and based at least in part on the configuration type.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: receiving, from a network node, configuration information that indicates a configuration type for wireless communications during one or more subband full-duplex (SBFD) time intervals and one or more non-SBFD time intervals; receiving, from the network node, control information that schedules a set of uplink messages; and transmitting, to the network node, a first uplink message from the set of uplink messages in accordance with the first uplink message being valid, wherein the first uplink message is valid in accordance with being scheduled during a valid symbol-type and based at least in part on the configuration type.

Aspect 2: The method of Aspect 1, wherein: the control information indicates a first hybrid automatic repeat request (HARQ) process identifier, the configuration type enables uplink transmissions during one of the one or more SBFD time intervals or the one or more non-SBFD time intervals, the valid symbol-type is SBFD symbols, and the first uplink message is valid and is associated with the first HARQ process identifier based at least in part on being an earliest uplink message scheduled in time of the set of uplink messages that is scheduled during exclusively one or more first SBFD symbols that do not overlap in time with a synchronization signal block (SSB).

Aspect 3: The method of Aspect 2, wherein a second uplink message of the set of uplink messages is valid and associated with a second HARQ process identifier based at least in part on being a next earliest uplink message after the first uplink message that is scheduled during exclusively one or more second SBFD symbols that do not overlap in time with an SSB, and wherein the second HARQ process identifier is incremented by one relative to the first HARQ process identifier.

Aspect 4: The method of any of Aspects 1-3, wherein: the control information indicates a first hybrid automatic repeat request (HARQ) process identifier, the configuration type enables uplink transmissions during one of the one or more SBFD time intervals or the one or more non-SBFD time intervals, the valid symbol-type is non-SBFD symbols, and the first uplink message is valid and is associated with the first HARQ process identifier based at least in part on being an earliest uplink message scheduled in time of the set of uplink messages that is scheduled during exclusively one or more first uplink or flexible symbols that do not overlap with downlink or SBFD symbols and do not overlap in time with a synchronization signal block (SSB).

Aspect 5: The method of Aspect 4, wherein a second uplink message of the set of uplink messages is valid and associated with a second HARQ process identifier based at least in part on being a next earliest uplink message after the first uplink message that is scheduled during exclusively one or more second uplink or flexible symbols that do not overlap with downlink or SBFD symbols and do not overlap in time with an SSB, and wherein the second HARQ process identifier is incremented by one relative to the first HARQ process identifier.

Aspect 6: The method of any of Aspects 1-5, wherein: the control information indicates a first hybrid automatic repeat request (HARQ) process identifier, the configuration type enables uplink transmissions during both the one or more SBFD time intervals and the one or more non-SBFD time intervals, and the first uplink message is valid and is associated with the first HARQ process identifier based at least in part on being an earliest uplink message scheduled in time of the set of uplink messages that is scheduled during exclusively one or more first uplink, flexible, or SBFD symbols that do not overlap in time with a synchronization signal block (SSB).

Aspect 7: The method of Aspect 6, wherein a second uplink message of the set of uplink messages is valid and associated with a second HARQ process identifier based at least in part on being a next earliest uplink message after the first uplink message that is scheduled during exclusively one or more second uplink, flexible, or SBFD symbols that do not overlap in time with an SSB, and wherein the second HARQ process identifier is incremented by one relative to the first HARQ process identifier.

Aspect 8: The method of any of Aspects 1-7, wherein: the control information comprises a DCI format 0_1 and indicates a set of start and length indicator values (SLIVs) respectively associated with the set of uplink messages, and the configuration type enables uplink transmissions during one of the one or more SBFD time intervals or the one or more non-SBFD time intervals.

Aspect 9: The method of Aspect 8, wherein: the valid symbol-type is SBFD symbols, and the first uplink message is valid based at least in part on being associated with an SLIV that schedules the first uplink message during exclusively one or more SBFD symbols that do not overlap in time with an SSB.

Aspect 10: The method of Aspect 8, wherein: the valid symbol-type is non-SBFD symbols, and the first uplink message is valid based at least in part on being associated with an SLIV that schedules the first uplink message during exclusively one or more uplink or flexible symbols that do not overlap with downlink or SBFD symbols and do not overlap in time with a synchronization signal block (SSB).

Aspect 11: The method of any of Aspects 1-10, wherein: the control information comprises a downlink control information (DCI) format 0_1 and indicates a set of start and length indicator values (SLIVs) respectively associated with the set of uplink messages, the configuration type enables uplink transmissions during both of the one or more SBFD time intervals or the one or more non-SBFD time intervals, and the first uplink message is valid based at least in part on being associated with an SLIV that schedules the first uplink message during exclusively one or more uplink, flexible, or SBFD symbols that do not overlap in time with a synchronization signal block (SSB).

Aspect 12: A method of wireless communication performed by a network node, comprising: transmitting, to a user equipment (UE), configuration information that indicates a configuration type for wireless communications during one or more subband full-duplex (SBFD) time intervals and one or more non-SBFD time intervals; transmitting, to the UE, control information that schedules a set of uplink messages; and receiving, from the UE, a first uplink message from the set of uplink messages in accordance with the first uplink message being valid, wherein the first uplink message is valid in accordance with being scheduled during a valid symbol-type and based at least in part on the configuration type.

Aspect 13: The method of Aspect 12, wherein: the control information indicates a first hybrid automatic repeat request (HARQ) process identifier, the configuration type enables uplink transmissions during one of the one or more SBFD time intervals or the one or more non-SBFD time intervals, the valid symbol-type is SBFD symbols, and the first uplink message is valid and is associated with the first HARQ process identifier based at least in part on being an earliest uplink message scheduled in time of the set of uplink messages that is scheduled during exclusively one or more first SBFD symbols that do not overlap in time with a synchronization signal block (SSB).

Aspect 14: The method of Aspect 13, wherein a second uplink message of the set of uplink messages is valid and associated with a second HARQ process identifier based at least in part on being a next earliest uplink message after the first uplink message that is scheduled during exclusively one or more second SBFD symbols that do not overlap in time with an SSB, and wherein the second HARQ process identifier is incremented by one relative to the first HARQ process identifier.

Aspect 15: The method of any of Aspects 12-14, wherein: the control information indicates a first hybrid automatic repeat request (HARQ) process identifier, the configuration type enables uplink transmissions during one of the one or more SBFD time intervals or the one or more non-SBFD time intervals, the valid symbol-type is non-SBFD symbols, and the first uplink message is valid and is associated with the first HARQ process identifier based at least in part on being an earliest uplink message scheduled in time of the set of uplink messages that is scheduled during exclusively one or more first uplink or flexible symbols that do not overlap with downlink or SBFD symbols and do not overlap in time with a synchronization signal block (SSB).

Aspect 16: The method of Aspect 15, wherein a second uplink message of the set of uplink messages is valid and associated with a second HARQ process identifier based at least in part on being a next earliest uplink message after the first uplink message that is scheduled during exclusively one or more second uplink or flexible symbols that do not overlap with downlink or SBFD symbols and do not overlap in time with an SSB, and wherein the second HARQ process identifier is incremented by one relative to the first HARQ process identifier.

Aspect 17: The method of any of Aspects 12-16, wherein: the control information indicates a first hybrid automatic repeat request (HARQ) process identifier, the configuration type enables uplink transmissions during both the one or more SBFD time intervals and the one or more non-SBFD time intervals, and the first uplink message is valid and is associated with the first HARQ process identifier based at least in part on being an earliest uplink message scheduled in time of the set of uplink messages that is scheduled during exclusively one or more first uplink, flexible, or SBFD symbols that do not overlap in time with a synchronization signal block (SSB).

Aspect 18: The method of Aspect 17, wherein a second uplink message of the set of uplink messages is valid and associated with a second HARQ process identifier based at least in part on being a next earliest uplink message after the first uplink message that is scheduled during exclusively one or more second uplink, flexible, or SBFD symbols that do not overlap in time with an SSB, and wherein the second HARQ process identifier is incremented by one relative to the first HARQ process identifier.

Aspect 19: The method of any of Aspects 12-18, wherein: the control information comprises a downlink control information (DCI) format 0_1 and indicates a set of start and length indicator values (SLIVs) respectively associated with the set of uplink messages, and the configuration type enables uplink transmissions during one of the one or more SBFD time intervals or the one or more non-SBFD time intervals.

Aspect 20: The method of Aspect 19, wherein: the valid symbol-type is SBFD symbols, and the first uplink message is valid based at least in part on being associated with an SLIV that schedules the first uplink message during exclusively one or more SBFD symbols that do not overlap in time with an SSB.

Aspect 21: The method of Aspect 19, wherein: the valid symbol-type is non-SBFD symbols, and the first uplink message is valid based at least in part on being associated with an SLIV that schedules the first uplink message during exclusively one or more uplink or flexible symbols that do not overlap with downlink or SBFD symbols and do not overlap in time with a synchronization signal block (SSB).

Aspect 22: The method of any of Aspects 12-21, wherein: the control information comprises a downlink control information (DCI) format 0_1 and indicates a set of start and length indicator values (SLIVs) respectively associated with the set of uplink messages, the configuration type enables uplink transmissions during both of the one or more SBFD time intervals or the one or more non-SBFD time intervals, and the first uplink message is valid based at least in part on being associated with an SLIV that schedules the first uplink message during exclusively one or more uplink, flexible, or SBFD symbols that do not overlap in time with a synchronization signal block (SSB).

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

Aspect 30: A device comprising a processing system that includes one or more processors and one or more code-storing memories coupled with the one or more processors, the processing system configured to cause the device to perform the method of one or more of Aspects 1-22.

Aspect 31: A device comprising a processing system that includes processor circuitry and code-storing memory circuitry, the processing system configured to cause the device to perform the method of one or more of Aspects 1-22.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, configuration information that indicates a configuration type for wireless communications during one or more subband full-duplex (SBFD) time intervals and one or more non-SBFD time intervals;
receive, from the network node, control information that schedules a set of uplink messages; and
transmit, to the network node, a first uplink message from the set of uplink messages in accordance with the first uplink message being scheduled during a time interval that is valid for transmission of the first uplink message based at least in part on the configuration type.

2. The UE of claim 1, wherein:
the control information indicates a first hybrid automatic repeat request (HARQ) process identifier,
the configuration type enables uplink transmissions during one of the one or more SBFD time intervals or the one or more non-SBFD time intervals,
the time interval is one or more symbols, and
the first uplink message is valid and is associated with the first HARQ process identifier based at least in part on being an earliest uplink message scheduled in time, of the set of uplink messages, that is scheduled during exclusively one or more first SBFD symbols that do not overlap in time with a synchronization signal block (SSB).

3. The UE of claim 2, wherein a second uplink message of the set of uplink messages is valid and associated with a second HARQ process identifier based at least in part on being a next earliest uplink message after the first uplink message that is scheduled during exclusively one or more second SBFD symbols that do not overlap in time with an SSB, and wherein the second HARQ process identifier is incremented by one relative to the first HARQ process identifier.

4. The UE of claim 1, wherein:
the control information indicates a first hybrid automatic repeat request (HARQ) process identifier,
the configuration type enables uplink transmissions during one of the one or more SBFD time intervals or the one or more non-SBFD time intervals,
the time interval is one or more symbols, and
the first uplink message is valid and is associated with the first HARQ process identifier based at least in part on being an earliest uplink message scheduled in time of the set of uplink messages that is scheduled during exclusively one or more first uplink or flexible symbols that do not overlap with downlink or SBFD symbols and do not overlap in time with a synchronization signal block (SSB).

5. The UE of claim 4, wherein a second uplink message of the set of uplink messages is valid and associated with a second HARQ process identifier based at least in part on being a next earliest uplink message after the first uplink message that is scheduled during exclusively one or more second uplink or flexible symbols that do not overlap with downlink or SBFD symbols and do not overlap in time with an SSB, and wherein the second HARQ process identifier is incremented by one relative to the first HARQ process identifier.

6. The UE of claim 1, wherein:
the control information indicates a first hybrid automatic repeat request (HARQ) process identifier,
the configuration type enables uplink transmissions during both the one or more SBFD time intervals or the one or more non-SBFD time intervals, and
the first uplink message is valid and is associated with the first HARQ process identifier based at least in part on being an earliest uplink message scheduled in time of the set of uplink messages that is scheduled during exclusively one or more first uplink, flexible, or SBFD symbols that do not overlap in time with a synchronization signal block (SSB).

7. The UE of claim 6, wherein a second uplink message of the set of uplink messages is valid and associated with a second HARQ process identifier based at least in part on being a next earliest uplink message after the first uplink message that is scheduled during exclusively one or more second uplink, flexible, or SBFD symbols that do not overlap in time with an SSB, and wherein the second HARQ process identifier is incremented by one relative to the first HARQ process identifier.

8. The UE of claim 1, wherein:
the control information is downlink control information (DCI), the DCI comprises a DCI format 0_1 and indicates a set of start and length indicator values (SLIVs) respectively associated with the set of uplink messages, and
the configuration type enables uplink transmissions during one of the one or more SBFD time intervals or the one or more non-SBFD time intervals.

9. The UE of claim 8, wherein:
the time interval is one or more symbols, and
the first uplink message is valid based at least in part on being associated with an SLIV that schedules the first uplink message during exclusively one or more SBFD symbols that do not overlap in time with a synchronization signal block (SSB).

10. The UE of claim 8, wherein:
the time interval is one or more symbols, and
the first uplink message is valid based at least in part on being associated with an SLIV that schedules the first uplink message during exclusively one or more uplink or flexible symbols that do not overlap with downlink or SBFD symbols and do not overlap in time with a synchronization signal block (SSB).

11. The UE of claim 1, wherein:
the control information is downlink control information (DCI), the DCI comprises a DCI format 0_1 and indicates a set of start and length indicator values (SLIVs) respectively associated with the set of uplink messages,
the configuration type enables uplink transmissions during both of the one or more SBFD time intervals or the one or more non-SBFD time intervals, and
the first uplink message is valid based at least in part on being associated with an SLIV that schedules the first uplink message during exclusively one or more uplink, flexible, or SBFD symbols that do not overlap in time with a synchronization signal block (SSB).

12. A network node for wireless communication, comprising:
one or more memories; and
one or more processors, coupled to the one or more memories, configured to cause the network node to:
transmit, to a user equipment (UE), configuration information that indicates a configuration type for wireless communications during one or more subband full-duplex (SBFD) time intervals and one or more non-SBFD time intervals;
transmit, to the UE, control information that schedules a set of uplink messages; and
receive, from the UE, a first uplink message from the set of uplink messages in accordance with the first uplink message being scheduled during a time interval that is valid for transmission of the first uplink message based at least in part on the configuration type.

13. The network node of claim 12, wherein:
the control information indicates a first hybrid automatic repeat request (HARQ) process identifier,
the configuration type enables uplink transmissions during one of the one or more SBFD time intervals or the one or more non-SBFD time intervals,
the valid symbol-type is SBFD symbols, and
the first uplink message is valid and is associated with the first HARQ process identifier based at least in part on being an earliest uplink message scheduled in time, of the set of uplink messages, that is scheduled during exclusively one or more first SBFD symbols that do not overlap in time with a synchronization signal block (SSB).

14. The network node of claim 13, wherein a second uplink message of the set of uplink messages is valid and associated with a second HARQ process identifier based at least in part on being a next earliest uplink message after the first uplink message that is scheduled during exclusively one or more second SBFD symbols that do not overlap in time with an SSB, and wherein the second HARQ process identifier is incremented by one relative to the first HARQ process identifier.

15. The network node of claim 12, wherein:
the control information indicates a first hybrid automatic repeat request (HARQ) process identifier,
the configuration type enables uplink transmissions during one of the one or more SBFD time intervals or the one or more non-SBFD time intervals,
the time interval is one or more symbols, and
the first uplink message is valid and is associated with the first HARQ process identifier based at least in part on being an earliest uplink message scheduled in time of the set of uplink messages that is scheduled during exclusively one or more first uplink or flexible symbols that do not overlap with downlink or SBFD symbols and do not overlap in time with a synchronization signal block (SSB).

16. The network node of claim 15, wherein a second uplink message of the set of uplink messages is valid and associated with a second HARQ process identifier based at least in part on being a next earliest uplink message after the first uplink message that is scheduled during exclusively one or more second uplink or flexible symbols that do not overlap with downlink or SBFD symbols and do not overlap in time with an SSB, and wherein the second HARQ process identifier is incremented by one relative to the first HARQ process identifier.

17. The network node of claim 12, wherein:
the control information indicates a first hybrid automatic repeat request (HARQ) process identifier,
the configuration type enables uplink transmissions during both the one or more SBFD time intervals or the one or more non-SBFD time intervals, and
the first uplink message is valid and is associated with the first HARQ process identifier based at least in part on being an earliest uplink message scheduled in time of the set of uplink messages that is scheduled during exclusively one or more first uplink, flexible, or SBFD symbols that do not overlap in time with a synchronization signal block (SSB).

18. The network node of claim 17, wherein a second uplink message of the set of uplink messages is valid and associated with a second HARQ process identifier based at least in part on being a next earliest uplink message after the first uplink message that is scheduled during exclusively one or more second uplink, flexible, or SBFD symbols that do not overlap in time with an SSB, and wherein the second HARQ process identifier is incremented by one relative to the first HARQ process identifier.

19. The network node of claim 12, wherein:
the control information is downlink control information (DCI), the DCI comprises a DCI format 0_1 and indicates a set of start and length indicator values (SLIVs) respectively associated with the set of uplink messages, and
the configuration type enables uplink transmissions during one of the one or more SBFD time intervals or the one or more non-SBFD time intervals.

20. The network node of claim 19, wherein:
the time interval is one or more symbols, and
the first uplink message is valid based at least in part on being associated with an SLIV that schedules the first uplink message during exclusively one or more SBFD symbols that do not overlap in time with a synchronization signal block (SSB).

21. The network node of claim 19, wherein:
the time interval is one or more symbols, and
the first uplink message is valid based at least in part on being associated with an SLIV that schedules the first uplink message during exclusively one or more uplink or flexible symbols that do not overlap with downlink or SBFD symbols and do not overlap in time with a synchronization signal block (SSB).

22. The network node of claim 12, wherein:
the control information is downlink control information (DCI), the DCI comprises a DCI format 0_1 and indicates a set of start and length indicator values (SLIVs) respectively associated with the set of uplink messages,
the configuration type enables uplink transmissions during both of the one or more SBFD time intervals or the one or more non-SBFD time intervals, and
the first uplink message is valid based at least in part on being associated with an SLIV that schedules the first uplink message during exclusively one or more uplink, flexible, or SBFD symbols that do not overlap in time with a synchronization signal block (SSB).

23. A method of wireless communication performed by a user equipment (UE), comprising:
receiving, from a network node, configuration information that indicates a configuration type for wireless communications during one or more subband full-duplex (SBFD) time intervals and one or more non-SBFD time intervals;
receiving, from the network node, control information that schedules a set of uplink messages; and
transmitting, to the network node, a first uplink message from the set of uplink messages in accordance with the first uplink message being scheduled during a time interval that is valid for transmission of the first uplink message based at least in part on the configuration type.

24. The method of claim 23, wherein:
the control information indicates a first hybrid automatic repeat request (HARQ) process identifier,
the configuration type enables uplink transmissions during one of the one or more SBFD time intervals or the one or more non-SBFD time intervals,
the time interval is one or more symbols, and
the first uplink message is valid and is associated with the first HARQ process identifier based at least in part on being an earliest uplink message scheduled in time, of the set of uplink messages, that is scheduled during exclusively one or more first SBFD symbols that do not overlap in time with a synchronization signal block (SSB).

25. The method of claim 24, wherein a second uplink message of the set of uplink messages is valid and associated with a second HARQ process identifier based at least in part on being a next earliest uplink message after the first uplink message that is scheduled during exclusively one or more second SBFD symbols that do not overlap in time with an SSB, and wherein the second HARQ process identifier is incremented by one relative to the first HARQ process identifier.

26. The method of claim 23, wherein:
the control information indicates a first hybrid automatic repeat request (HARQ) process identifier,
the configuration type enables uplink transmissions during one of the one or more SBFD time intervals or the one or more non-SBFD time intervals,
the time interval is one or more symbols, and
the first uplink message is valid and is associated with the first HARQ process identifier based at least in part on being an earliest uplink message scheduled in time of the set of uplink messages that is scheduled during exclusively one or more first uplink or flexible symbols that do not overlap with downlink or SBFD symbols and do not overlap in time with a synchronization signal block (SSB).

27. The method of claim 26, wherein a second uplink message of the set of uplink messages is valid and associated with a second HARQ process identifier based at least in part on being a next earliest uplink message after the first uplink message that is scheduled during exclusively one or more second uplink or flexible symbols that do not overlap with downlink or SBFD symbols and do not overlap in time with an SSB, and wherein the second HARQ process identifier is incremented by one relative to the first HARQ process identifier.

28. The method of claim 23, wherein:
the control information indicates a first hybrid automatic repeat request (HARQ) process identifier,
the configuration type enables uplink transmissions during both the one or more SBFD time intervals or the one or more non-SBFD time intervals, and
the first uplink message is valid and is associated with the first HARQ process identifier based at least in part on being an earliest uplink message scheduled in time of the set of uplink messages that is scheduled during exclusively one or more first uplink, flexible, or SBFD symbols that do not overlap in time with a synchronization signal block (SSB).

29. The method of claim 28, wherein a second uplink message of the set of uplink messages is valid and associated with a second HARQ process identifier based at least in part on being a next earliest uplink message after the first uplink message that is scheduled during exclusively one or more second uplink, flexible, or SBFD symbols that do not overlap in time with an SSB, and wherein the second HARQ process identifier is incremented by one relative to the first HARQ process identifier.

30. A method of wireless communication performed by a network node, comprising:
transmitting, to a user equipment (UE), configuration information that indicates a configuration type for wireless communications during one or more subband full-duplex (SBFD) time intervals and one or more non-SBFD time intervals;
transmitting, to the UE, control information that schedules a set of uplink messages; and
receiving, from the UE, a first uplink message from the set of uplink messages in accordance with the first uplink message being scheduled during a time interval that is valid for transmission of the first uplink message based at least in part on the configuration type.
